(19) United States
(12) Patent Application Publication
(10) Pub. No.: US 2025/0222893 A1
(43) Pub. Date: Jul. 10, 2025

(54) VEHICLE AND FLIGHT VEHICLE

(71) Applicant: TS TECH CO., LTD., Asaka-shi, Saitama (JP)

(72) Inventors: Atsushi YAMABE, Tochigi (JP); Munetaka KOWA, Tochigi (JP); Hayato SHIDA, Tochigi (JP); Akira MIYOSHI, Tochigi (JP)

(21) Appl. No.: 18/850,982

(22) PCT Filed: Mar. 27, 2023
(86) PCT No.: PCT/JP2023/012176

§ 371 Date: Sep. 25, 2024

Related U.S. Application Data
(60) Provisional application No. 63/489,821, filed on Mar. 13, 2023.

(30) Foreign Application Priority Data
Mar. 28, 2022 (JP) 2022-052406
Mar. 31, 2022 (JP) 2022-057898

(51) Int. Cl. B60R 21/231; B60N 2/01; B60R 21/00; B60R 21/207; B60R 21/214; B64D 11/06

(52) U.S. Cl. CPC B60R 21/231; B60N 2/01; B60R 21/207; B60R 21/214; B64D 11/0619; B60R 2021/0046; B60R 2021/0093; B60R 2021/2078; B60R 2021/23153; B60R 2021/23161; B60R 2021/23192

(57) ABSTRACT

A vehicle includes: a front seat capable of changing a posture between a first posture in which a seating surface of the front seat faces forward and a second posture in which the seating surface of the front seat faces backward; a rear seat disposed behind the front seat, a seating surface of the rear seat facing forward; and a protective device emerging between the front seat and the rear seat when impact force acts on the vehicle or when impact force is predicted to act on the vehicle.

### TECHNICAL FIELD

The present invention relates to a vehicle including front seats and rear seats that can face each other.

### BACKGROUND ART

As this type of vehicle, there is known a vehicle configured such that front seats and rear seats can face each other by rotating the front seats (see, for example, Patent Literature 1). The vehicle described in Patent Literature 1 is a vehicle capable of automatic driving, and it is possible to allow occupants seated on a driver seat and a passenger seat and occupants seated on rear seats to face each other during traveling in automatic driving.

### CITATION LIST

### Patent Literature

Patent Literature 1: Japanese Unexamined Patent Publication No. 2017-39400

### SUMMARY OF INVENTION

### Technical Problem

However, in the vehicle described in Patent Literature 1, since the occupants travel in a state of facing each other, there is a possibility that their legs collide vigorously when an impact force acts on the subject vehicle.

### Solution to Problem

An aspect of the present invention is a vehicle, including: a front seat capable of changing a posture between a first posture in which a seating surface of the front seat faces forward and a second posture in which the seating surface of the front seat faces backward; a rear seat disposed behind the front seat, a seating surface of the rear seat facing forward; and a protective device emerging between the front seat and the rear seat when impact force acts on the vehicle or when impact force is predicted to act on the vehicle.

### Advantageous Effects of the Invention

According to the present invention, even when an impact force acts on the subject vehicle while the occupants are traveling while facing each other, it is possible to prevent the legs from vigorously colliding with each other.

### BRIEF DESCRIPTION OF DRAWINGS

FIG. 1A A plan view illustrating a first seat layout of a vehicle according to a first embodiment of the present invention

FIG. 1B A plan view illustrating a second seat layout in which front seats and rear seats according to the first embodiment face each other

FIG. 2 A side view illustrating a floor airbag module provided between the front seat in a second posture and the rear seat illustrated in FIG. 1B

FIG. 3 A block diagram illustrating a schematic configuration of an airbag ECU mounted on the vehicle according to the first embodiment

FIG. 4 A flowchart illustrating an example of processing executed by the airbag ECU of FIG. 3

FIG. 5 A side view illustrating a floor airbag module movable integrally with a rear seat included in a vehicle according to a first modification of the first embodiment

FIG. 6 A cross-sectional view illustrating a configuration of a main part of a seat cushion provided in a rear seat included in a vehicle according to a second modification of the first embodiment

FIG. 7A A side view illustrating a state in which a foot airbag of FIG. 6 is inflated and deployed

FIG. 7B A cross-sectional view taken along line VII-VII of FIG. 7A

FIG. 8A A plan view illustrating a first seat layout of a vehicle according to a second embodiment

FIG. 8B A plan view illustrating a second seat layout of the vehicle according to the second embodiment

FIG. 9 A side view illustrating the floor airbag module provided between the front seat in the second posture and the rear seat illustrated in FIG. 8B

FIG. 10 A side view illustrating a roof airbag module provided on a ceiling of a vehicle according to a third embodiment

FIG. 11 A side view illustrating the roof airbag module and a detection device according to a third modification

FIG. 12 A side view illustrating the roof airbag module and the floor airbag module provided in a vehicle according to a fourth embodiment

FIG. 13 A side view illustrating a roof airbag module and a floor airbag module according to a modification of the fourth embodiment

FIG. 14 A side view illustrating a table provided between a front seat in a second posture and a rear seat of a vehicle according to a fifth embodiment

FIG. 15 A side view illustrating two floor airbag modules provided in a table according to a modification of the fifth embodiment

FIG. 16 A plan view illustrating a configuration of a main part of a flight vehicle according to a sixth embodiment of the present invention

FIG. 17 A perspective view illustrating a configuration of a main part of seats disposed in a cabin of the flight vehicle

FIG. 18 A perspective view showing a configuration of a main part of a seat frame incorporated in a seat part

FIG. 19 A cross-sectional view showing a configuration of a main part of a seat cushion incorporating a cushion airbag module and a foot airbag module

FIG. 20A A side view schematically illustrating a state in which a cushion airbag and a foot airbag are deployed

FIG. 20B A cross-sectional view taken along line XX-XX of FIG. 20A

FIG. 21 A block diagram illustrating a configuration of a main part of an airbag ECU

FIG. 22 A flowchart illustrating an example of deployment processing executed by the airbag ECU

### DESCRIPTION OF EMBODIMENT

### First Embodiment

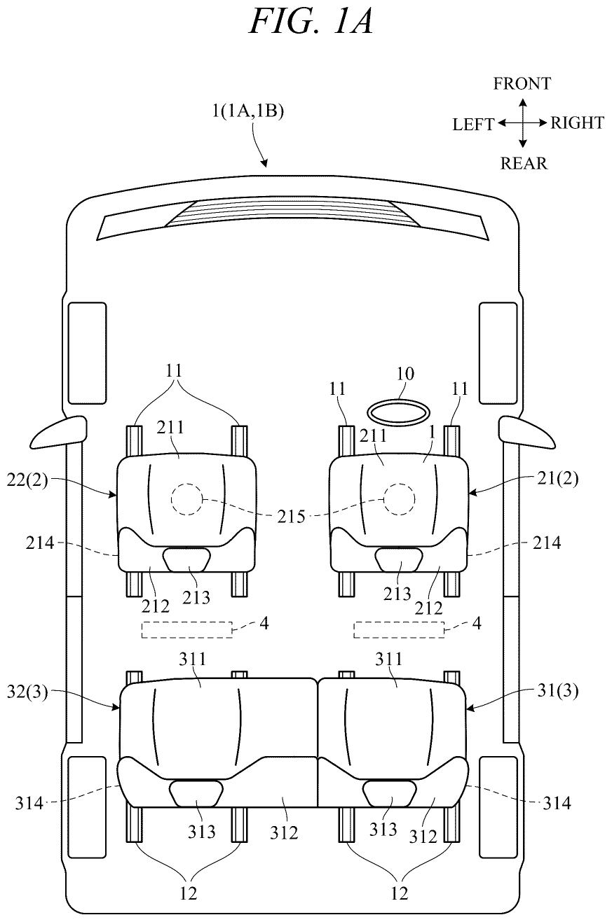

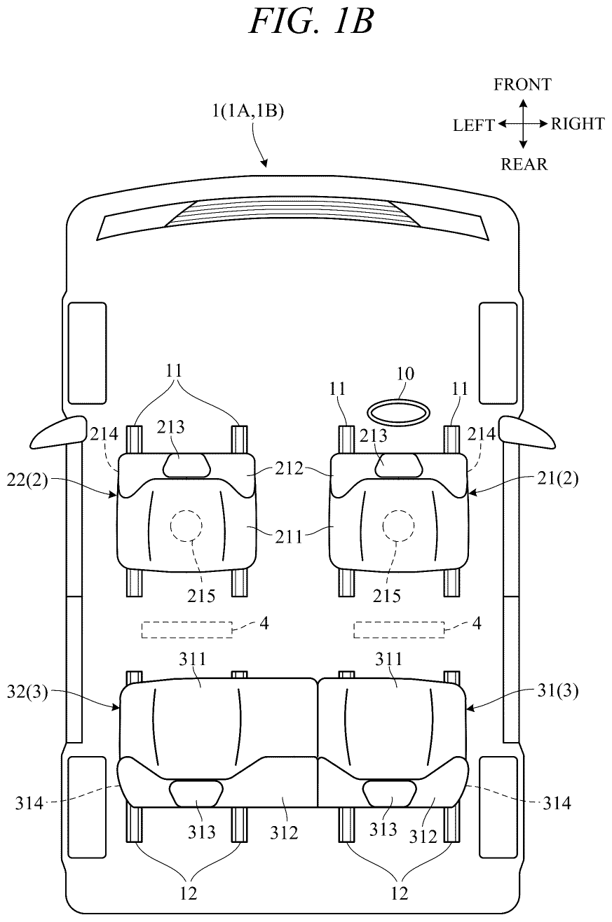

An embodiment of the present invention will be described below with reference to the drawings. First, a first embodiment of the present invention will be described with reference to FIGS. 1A to 7B. The vehicle according to the first embodiment of the present invention is applicable to a vehicle in which a front seat and a rear seat are configured to be able to face each other, for example, a vehicle capable of turning a seating surface of the front seat to face backward by rotating the front seat by 180 degrees or rotating a seat back of the front seat from the rear to the front. Hereinafter, an example in which the present invention is applied to a vehicle in which a front seat is rotated by 180 degrees and a front seat and a rear seat can face each other will be described.

The vehicle having the above configuration is suitably used for a vehicle having an automatic driving function, that is, an automatic driving vehicle. In the case of the automatic driving vehicle, during traveling in the automatic driving, the occupants seated on the driver seat and the passenger seat and the occupants seated on the rear seats can enjoy conversation and the like in a state of facing each other. The vehicle may be any of an engine vehicle having an internal combustion engine as a traveling drive source, an electric vehicle having a traveling motor as a traveling drive source, and a hybrid vehicle having an engine and a traveling motor as traveling drive sources. However, in the case of an automatic driving vehicle, the vehicle is preferably an electric vehicle.

First, the configuration of the main parts of front seats 2 and rear seats 3 included in a vehicle 1 according to the first embodiment will be described. FIG. 1A is a plan view illustrating a first seat layout of the vehicle 1 according to the first embodiment. Note that, in the following, for convenience, the front-rear direction (length direction), the left-right direction (vehicle width direction), and the up-down direction (height direction) are defined as illustrated in the drawing, and the configuration of each part will be described according to this definition.

As illustrated in FIG. 1A, the vehicle 1 includes a driver seat 21 disposed facing a steering wheel 10 to be operated by a driver, a passenger seat 22 disposed on a side of the driver seat 21, and rear seats 3 disposed behind the driver seat 21 and the passenger seat 22. The driver seat 21 and the passenger seat 22 are provided independently and separately in the left and right directions, and are referred to as front seats 2. The rear seats 3 includes a driver seat side rear seat 31 located behind the driver seat 21 and a passenger seat side rear seat 32 located behind the passenger seat 22 in succession without separating on either side.

The front seats 2 each include a seat cushion 211 that supports the hip of the occupant, a seat back 212 that supports the back of the occupant, and a headrest 213 that supports the head of the occupant. The seat cushion 211 includes a pair of left and right engaging portions (not illustrated) slidably engaged with a pair of left and right slide rails 11 extending on the floor in the front-rear direction, and is configured to be movable on the slide rails 11. The seat back 212 is disposed at a rear end portion of the seat cushion 211 and is configured to be tiltable with respect to the seat cushion 211 via a reclining mechanism 214. The headrest 213 is provided at an upper end of the seat back 212, and is configured to change a height position with respect to the seat back 212 in accordance with a position of a head of an occupant.

The rear seats 3 constitutes a so-called bench seat in which a driver seat side rear seat 31 and a passenger seat side rear seat 32 are provided continuously on the left and right. The driver seat side rear seat 31 and the passenger seat side rear seat 32 are configured to be independently movable, and the passenger seat side rear seat 32 is longer in the left-right direction (vehicle width direction) than the driver seat side rear seat 31.

More specifically, each of the driver seat side rear seat 31 and the passenger seat side rear seat 32 includes a seat cushion 311 that supports the hip of the occupant, a seat back 312 that supports the back of the occupant, and a headrest 313 that supports the head of the occupant. Each seat cushion 311 includes a pair of left and right engaging portions (not illustrated) slidably engaged with a pair of left and right slide rails 12 extending on the floor in the front-rear direction, and is configured to be movable on the slide rails 12. Each of the seat backs 312 is disposed at a rear end of the seat cushion 311 and is configured to be tiltable with respect to the seat cushion 311 via the reclining mechanism 314. Each of the headrests 313 is provided at an upper end of the seat back 312, and is configured to change a height position with respect to the seat back 312 in accordance with a position of the head of the occupant.

In the first seat layout illustrated in FIG. 1A, the seating surfaces of the front seat 2 and the rear seat 3 face forward, and the seating surfaces of the front seat 2 and the rear seat 3 do not face each other. Such a posture of the front seat 2 in which the seating surface faces forward is referred to as a first posture.

FIG. 1B is a plan view illustrating a second seat layout in which the front seats 2 and the rear seats 3 according to the first embodiment face each other. As shown in FIGS. 1A and 1B, each of the front seats 2 further includes a rotation mechanism 215 that rotates the seat cushion 211 about a rotation axis in the up-down direction. The rotation mechanism 215 is provided under the seat cushion 211. More specifically, the rotation mechanism 215 is provided between the pair of left and right slide rails 11 and the seat cushion 211, and the direction of the front seat 2 can be changed by 180 degrees by the rotation mechanism 215, and the front seat 2 can be slid in the front-rear direction by the pair of left and right slide rails 11 even after the direction is changed.

In the second seat layout illustrated in FIG. 1B, the seating surface of each of the front seats 2 faces backward and the seating surface of each of the rear seats 3 faces forward, and the front seats 2 and the rear seats 3 face each other. Such a posture of the front seat 2 in which the seating surface faces backward is referred to as a second posture. The front seat 2 is configured to be posture-changeable from a first posture (FIG. 1A) in which the seating surface faces forward to a second posture (FIG. 1B) in which the seating surface faces backward by the rotation mechanism 215.

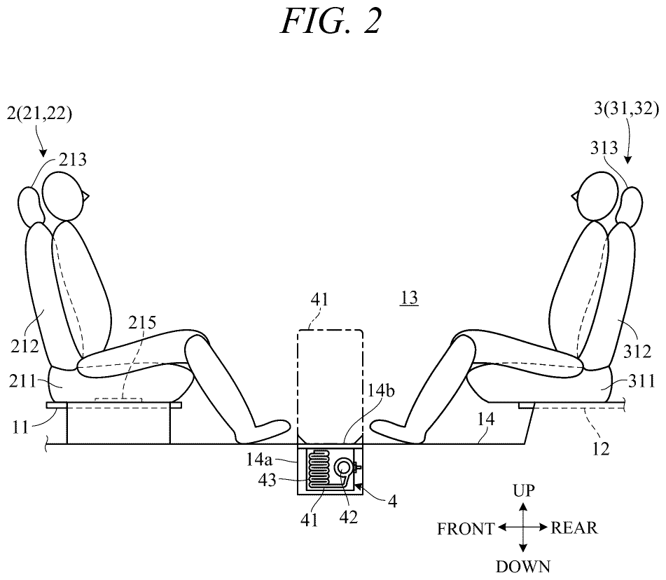

Next, a floor airbag module 4 included in the vehicle 1 according to the first embodiment will be described. FIG. 2 is a side view illustrating the floor airbag module 4 provided between the front seat 2 in the second posture and the rear seat 3 illustrated in FIG. 1B. Hereinafter, the vehicle 1 may be referred to as a subject vehicle 1 to be distinguished from other vehicles.

As illustrated in FIG. 2, the vehicle 1 includes a floor airbag 41 provided between the front seat 2 in the second posture and the rear seat 3 and emerges between the front seat 2 and the rear seat 3 when an impact force acts on the subject vehicle 1 or when an impact force is predicted to act on the subject vehicle 1. The floor airbag 41 is respectively provided between the driver seat 21 in the second posture and the driver seat side rear seat 31, and between the passenger seat 22 in the second posture and the passenger seat side rear seat 32 (see FIG. 1B).

The floor airbag 41 is accommodated in the floor airbag module 4, and the floor airbag module 4 constitutes a protective device that inflates and deploys the floor airbag 41 between the occupant seated on the front seat 2 in the second posture and the occupant seated on the rear seat 3 to protect the legs of the occupants when an impact force acts on the subject vehicle 1 or when an impact force is predicted to act on the subject vehicle 1.

The floor airbag module 4 is provided on the floor surface 14 in a vehicle interior 13 of the vehicle 1 so that the floor airbag 41 is inflated and deployed upward from the lower side. The floor surface 14 has a recess 14a formed in a recessed shape downward, and the floor airbag module 4 is accommodated in the recess 14a so as not to protrude from the floor surface 14. The recess 14a is formed in a substantially rectangular parallelepiped shape that is long in the left-right direction as a whole, and the floor airbag module 4 is formed in substantially the same shape as the recess 14a. By accommodating the floor airbag module 4 so as not to protrude from the floor surface 14, the legs of the occupants seated on the front seat 2 and the rear seat 3 do not come into contact with the floor airbag module 4, and the ride comfort of the occupants of the vehicle 1 is prevented from being impaired.

The recess 14a is covered with a lid 14b so that the floor airbag module 4 is not exposed from the floor surface 14. The lid 14b is provided with a rupture portion (not illustrated), which is ruptured when the floor airbag 41 is inflated and deployed, and the floor airbag 41 emerges in the vehicle interior 13 via the rupture portion.

The floor airbag module 4 includes the floor airbag 41 and an inflator 42, and the floor airbag 41 and the inflator 42 are accommodated in a module case 43. Both the floor airbag 41 and the inflator 42 are wrapped in a wrap material or the like and accommodated in the module case 43.

The inflator 42 is a device that generates gas in response to an input signal from a harness (not illustrated in the drawings). An airbag ECU 5 to be described later outputs an operation signal to the inflator 42 when acceleration detected by an acceleration sensor 15 to be described later is equal to or greater than a preset threshold, or when a monitoring target object whose collision probability calculated by a collision prediction unit 16 to be described later is equal to or greater than a predetermined value is detected. When the operation signal is input to the inflator 42, the inflator 42 generates gas to inject the gas into the floor airbag 41. As a result, the floor airbag 41 bulges upward from the floor surface 14 and is deployed between the front seat 2 in the second posture and the rear seat 3.

The floor airbag 41 is configured to bulge and deploy between legs of an occupant seated in the front seat 2 (driver seat 21, passenger seat 22) in the second posture and legs of an occupant seated in the rear seat 3 (driver seat side rear seat 31, passenger seat side rear seat 32). For example, the floor airbag 41 is accommodated in the module case 43 by being folded so as to be able to expand and deploy between the front seat 2 in the second posture and the rear seat 3, and is inflated when gas is injected, and bulges and deploys from a rupture portion formed in the lid 14b.

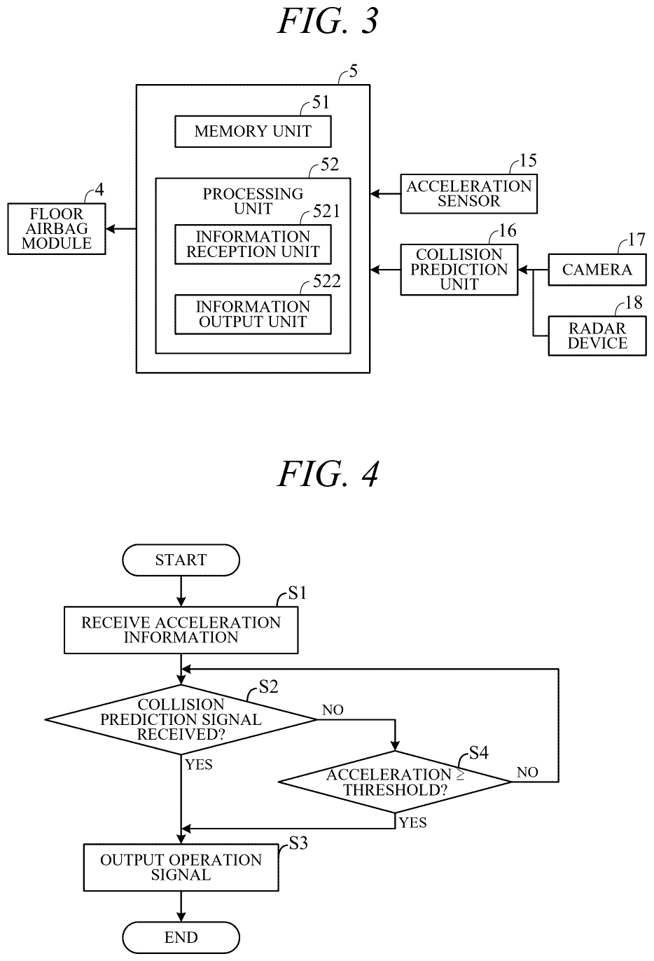

Next, the airbag ECU 5 that controls the floor airbag module 4 will be described. FIG. 3 is a block diagram illustrating a schematic configuration of the airbag ECU 5 mounted on the vehicle 1 according to the first embodiment.

As illustrated in FIG. 3, the floor airbag module 4, the acceleration sensor 15, a collision prediction unit 16, and the like are connected to the airbag ECU 5. The acceleration sensor 15 detects acceleration of the traveling vehicle 1, acceleration generated in the vehicle 1 due to collision or the like, and outputs the detected acceleration information to the airbag ECU 5. The acceleration sensor 15 includes a front-rear acceleration sensor that detects acceleration in the front-rear direction of the vehicle 1, a lateral acceleration sensor that detects lateral acceleration in the left-right direction of the vehicle 1, a vertical acceleration sensor that detects acceleration in the up-down direction of the vehicle 1, and the like.

A camera 17 and a radar device 18 are connected to the collision prediction unit 16. The camera 17 is provided on the vehicle interior side at the upper portion of the windshield of the vehicle 1, acquires imaging information around the subject vehicle 1 by capturing an external situation of the subject vehicle 1, and outputs the acquired imaging information to the collision prediction unit 16.

The radar device 18 detects objects such as pedestrians and other vehicles present around the subject vehicle 1, such as the front, rear, left, and right of the subject vehicle 1. The radar device 18 transmits radio waves (for example, millimeter waves) around the vehicle 1 and detects an object by receiving radio waves reflected by obstacles. The radar device 18 acquires the relative position and the relative speed between the detected object and the subject vehicle 1, and outputs the acquired relative position information and relative speed information to the collision prediction unit 16.

The collision prediction unit 16 detects the position of the object on the image input from the camera 17 on the basis of the relative position information and the relative speed information input from the radar device 18. In addition, the collision prediction unit 16 determines the type of the object (pedestrian, vehicle, or the like) from the characteristics of the detected object. The collision prediction unit 16 repeats the processing described above at a predetermined cycle, monitors the objects existing around the subject vehicle 1, and calculates the collision probability with the subject vehicle 1 for each monitor target object.

When detecting a monitored object having a collision probability with the subject vehicle 1 of a preset value or more, the collision prediction unit 16 predicts that the subject vehicle 1 and the monitored object will collide, and outputs a collision prediction signal to the airbag ECU 5. That is, the collision prediction signal is output before the collision is detected by the acceleration sensor 15. The collision prediction signal also includes information indicating the collision mode (frontal collision, side collision, and rear collision) between the subject vehicle 1 and the collision object.

The airbag ECU 5 includes a computer including a memory unit 51 such as a ROM, a RAM, and a hard disk, a processing unit 52 such as a CPU, and other peripheral circuits (not illustrated). The memory unit 51 stores various programs executed by the processing unit 52, various data, and the like. The memory unit 51 stores control data and the like for controlling the floor airbag module 4 on the basis of the acceleration information detected by the acceleration sensor 15. For example, a threshold of acceleration or the like when an operation signal is output to the inflator 42 of the floor airbag module 4 is stored.

The processing unit 52 includes an information reception unit 521 and an information output unit 522 as functional configurations. The information reception unit 521 receives the acceleration information transmitted from the acceleration sensor 15, the collision prediction signal transmitted from the collision prediction unit 16, and the like. The information output unit 522 outputs a predetermined signal to each unit on the basis of various types of information, signals, and the like received by the information reception unit 521. For example, when the collision prediction signal is input from the collision prediction unit 16, the information output unit 522 outputs an operation signal to the inflator 42. In addition, the information output unit 522 outputs an operation signal to the inflator 42 in a case where the acceleration detected by the acceleration sensor 15 is equal to or greater than a preset threshold.

Next, an example of deployment processing of the floor airbag 41 executed by the airbag ECU 5 included in the vehicle 1 according to the first embodiment configured as described above will be described. FIG. 4 is a flowchart illustrating an example of processing executed by the airbag ECU 5 of FIG. 3.

First, in step S1, the acceleration information output from the acceleration sensor 15 is received by the processing in the information reception unit 521. Next, in step S2, it is determined whether or not the collision prediction signal output from the collision prediction unit 16 has been received by processing in the information reception unit 521. When affirmative determination is made in step S2, the processing proceeds to step S3, and the operation signal is output to the inflator 42 of the floor airbag module 4 by the processing in the information output unit 522, and the processing is terminated.

On the other hand, when negative determination is made in step S2, the processing proceeds to step S4, and by the processing in the information output unit 522, it is determined whether or not the acceleration information received by the information reception unit 521 is greater than or equal to a preset threshold. When negative determination is made in step S4, the processing returns to step S2, and when affirmative determination is made in step S4, the processing proceeds to step S3. In the same manner as described above, the operation signal is output to the inflator 42 of the floor airbag module 4 by the processing in the information output unit 522, and the processing is terminated.

According to the first embodiment, the following effects can be obtained.
(1) The vehicle 1 according to the first embodiment includes a front seat 2 (driver seat 21, passenger seat 22) capable of changing a posture between a first posture in which a seating surface faces forward and a second posture in which the seating surface faces backward, a rear seat 3 (driver seat side rear seat 31, passenger seat side rear seat 32) disposed behind the front seat 2 and in which the seating surface faces forward, and a protective device that emerges between the front seat 2 (driver seat 21, passenger seat 22) and the rear seat 3 (driver seat side rear seat 31, passenger seat side rear seat 32) when an impact force acts on the subject vehicle 1 or when an impact force is predicted to act on the subject vehicle 1 (FIGS. 1A to 2).

With this configuration, the protective device emerges between the occupants facing each other when an impact force acts on the subject vehicle 1 during traveling in a state where the occupants face each other, so that it is possible to prevent the legs from vigorously colliding with each other. In addition, since the protective device emerges even when the action of the impact force on the subject vehicle 1 is predicted, it is possible to prevent the legs from vigorously colliding with each other when the impact force acts on the vehicle 1 thereafter. In particular, since the protective device emerges before the impact force acts on the subject vehicle 1, it is possible to prevent the legs from vigorously colliding with each other regardless of the timing at which the subsequent impact force acts.
(2) The above-described protective device includes a floor airbag 41 that is provided between a front seat 2 (driver seat 21, passenger seat 22) in a second posture and a rear seat 3 (driver seat side rear seat 31, passenger seat side rear seat 32), and is inflated and deployed between the front seat 2 in the second posture and the rear seat 3 (FIG. 2).

With this configuration, the floor airbag 41 emerges between the front seat 2 in the second posture and the rear seat 3 when an impact force acts on the subject vehicle 1 during traveling in a state where the occupants face each other, so that it is possible to prevent the legs from vigorously colliding with each other. In particular, since the floor airbag 41 emerges before the impact force acts on the subject vehicle 1, it is possible to prevent the legs from vigorously colliding with each other regardless of the timing at which the subsequent impact force acts.
(3) The floor airbag 41 is disposed on the floor surface 14 so as to be inflated and deployed upward from the lower side (FIG. 2). With this configuration, the floor airbag 41 easily emerges between the feet of the occupant seated in the front seat 2 in the second posture and the feet of the occupant seated in the rear seat 3.
(4) The floor surface 14 has the recess 14a formed in a recessed shape downward. The floor airbag module 4 is accommodated in the recess 14a. With this configuration, the floor airbag module 4 can be accommodated so as not to protrude from the floor surface 14. Therefore, the legs of the occupants sitting on the front seat 2 and the rear seat 3 do not come into contact with the floor airbag module 4, and the ride comfort of the occupants of the vehicle 1 can be prevented from being impaired.

The above-described first embodiment can be modified into various modes. Hereinafter, modifications of the first embodiment will be described. Note that, in the following modifications, the same reference signs are given to the same configurations as those of the first embodiment, and the description thereof will be omitted, and differences from the first embodiment will be mainly described.

### First Modification

Although the floor airbag module 4 is accommodated in the recess 14a of the floor surface 14 in the first embodiment described above, the floor airbag module 4 accommodated in the recess 14a may be configured to move integrally with the rear seat 3 or in conjunction with the movement of the rear seat 3. For example, the floor airbag module 4 and the rear seat 3 may be connected to each other, and the recess 14a may extend in the front-rear direction so that the floor airbag module 4 can move in the front-rear direction in the recess 14a.

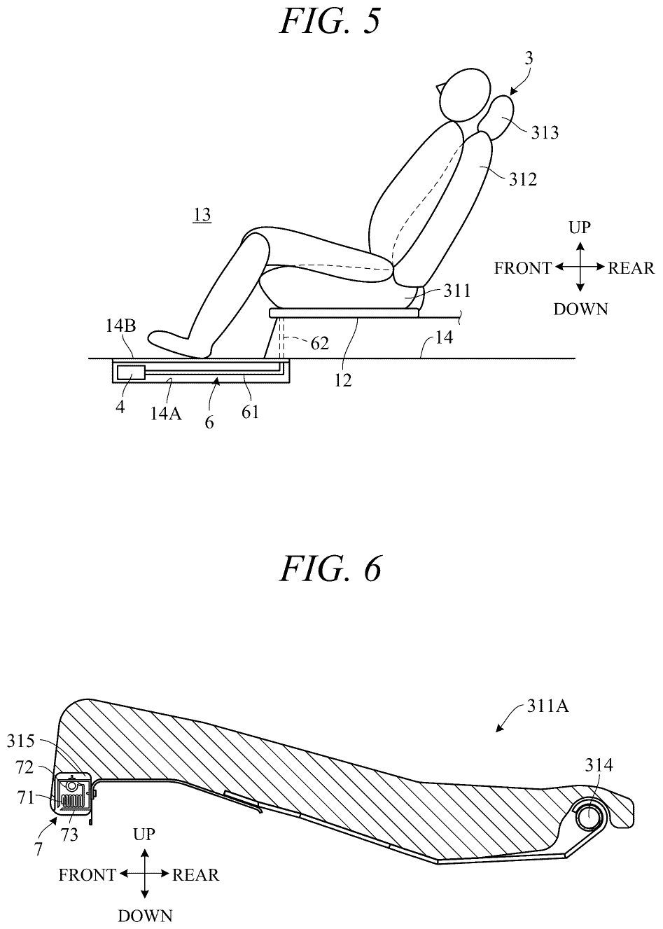

FIG. 5 is a side view illustrating a floor airbag module 4 movable integrally with a rear seat 3 included in a vehicle 1A (see FIGS. 1A and 1B) according to a first modification of the first embodiment. As illustrated in FIG. 5, the floor airbag module 4 and the rear seat 3 of the vehicle 1A according to the first modification are connected by a connecting part 6. The connecting part 6 includes a pair of left and right first arms 61 extending in the front-rear direction and a pair of left and right second arms 62 extending in the up-down direction. The front end of each of the pair of left and right first arms 61 is connected to both ends of the floor airbag module 4, and the rear end of each of the pair of left and right first arms 61 is connected to the lower end of each of the pair of left and right second arms 62. The upper end of each of the pair of left and right second arms 62 is connected to the seat frame of the rear seat 3.

More specifically, the seat cushion 311 of the rear seat 3 is mounted on the upper end of each of the pair of left and right second arms 62, and the upper end is connected to a seat cushion frame (not illustrated) serving as a skeleton of the seat cushion 311. The seat cushion frame is formed along an outer shape of the seat cushion 311, and upper ends of the pair of left and right second arms 62 extend in the front-rear direction and are connected to a pair of left and right side frames constituting left and right side portions of the seat cushion frame.

The recess 14a provided in the floor surface 14 is formed in a recessed shape extending in the front-rear direction and the left-right direction, the length in the front-rear direction corresponds to the slidable length of the seat cushion 311, and the length in the left-right direction is slightly longer than the length in the left-right direction of the floor airbag module 4 connected to the connecting part 6. In this manner, the recess 14a is formed in a size that allows the floor airbag module 4 connected to the connecting part 6 to move integrally with the rear seat 3. The lid 14b is formed in a substantially rectangular shape extending in the front-rear direction and the left-right direction, and is formed in a plate shape covering the recess 14a. The lid 14b is provided with a plurality of rupture portions so that the floor airbag 41 can emerge from the rupture portion even when the floor airbag module 4 moving integrally with the rear seat 3 moves to any position.

Since the floor airbag module 4 is configured to move integrally with the rear seat 3, the floor airbag 41 can always emerge under the feet of the occupants each seated on the rear seat 3, and it is possible to more reliably prevent the legs of the occupants from vigorously colliding with each other.

### Second Modification

In the first embodiment described above, the floor airbag module 4 that emerges from the floor surface 14 in the vehicle interior 13 has been described as the protective device. However, a foot airbag module 7 that emerges from the seat cushion 311 of the rear seat 3 and deploys between the front seat 2 in the second posture and the rear seat 3 may be used.

FIG. 6 is a cross-sectional view illustrating a configuration of a main part of a seat cushion 311A provided in a rear seat 3 included in a vehicle 1B (see FIGS. 1A and 1B) according to a second modification of the first embodiment. The seat cushion 311A is composed by mounting a cushion pad made of a cushion material such as urethane foam or the like on the seat cushion frame serving as a skeleton and covering the outside thereof with a skin material made of synthetic leather, fabric, or the like. As illustrated in FIG. 6, the seat cushion 311A includes an airbag accommodation part 315 that accommodates the foot airbag module 7. The airbag accommodation part 315 is formed in a substantially rectangular parallelepiped shape that is long in the left-right direction as a whole, and is disposed along the left-right direction at the front end portion of the seat cushion 311 A.

The foot airbag module 7 accommodated in the airbag accommodation part 315 is inflated and deployed when an impact force acts on a subject vehicle 1B or when an impact force is predicted to act on the subject vehicle 1B, thereby constituting a protective device that protects the legs of the occupants. The foot airbag module 7 may be a caseless airbag module without a module case or may be a module case that includes a module case. In FIG. 6, the foot airbag module 7 includes a module case 73.

The foot airbag module 7 includes a foot airbag 71 and an inflator 72. Both the foot airbag 71 and the inflator 72 are wrapped in a wrap material or the like and accommodated in the module case 73. The inflator 72 is a device that generates gas in response to an input signal from a harness (not illustrated in the drawings). The airbag ECU 5 outputs an operation signal to the inflator 72 when the collision prediction signal is input from the collision prediction unit 16 or in a case where the acceleration detected by the acceleration sensor 15 is equal to or greater than a preset threshold. When the operation signal is input to the inflator 72, the inflator 72 generates gas to inject the gas into the foot airbag 71. As a result, the foot airbag 71 emerges at the feet of the occupants and protects both legs of the occupant. At this time, the foot airbag 71 is inflated and deployed so as to wrap both legs of the occupant.

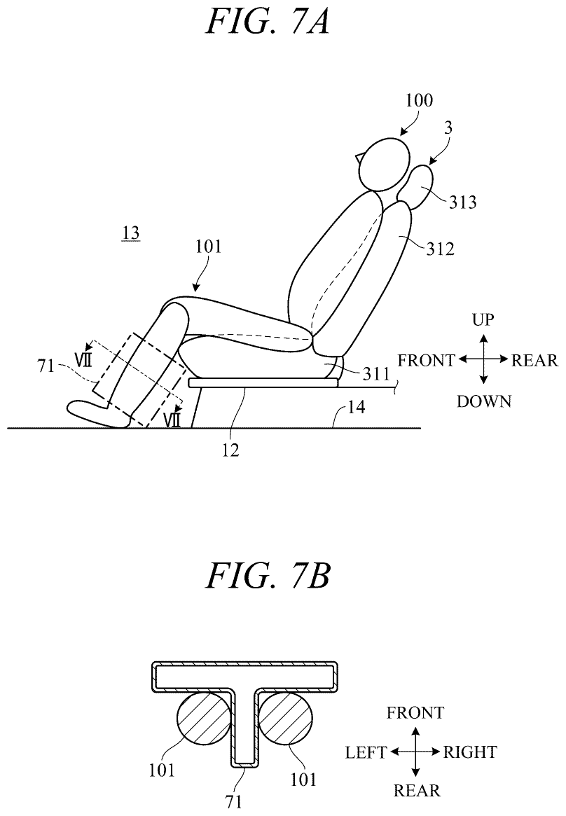

FIG. 7A is a side view illustrating a state in which the foot airbag 71 of FIG. 6 is inflated and deployed, and FIG. 7B is a cross-sectional view taken along line VII-VII of FIG. 7A. As shown in FIG. 7A, the foot airbag 71 emerges on the back side (calf side) of both legs 101 of the occupant 100, and as shown in FIG. 7B, the foot airbag 71 is deployed in front of the knees of both the legs 101 via a gap (between the knees) below the knees of both legs 101. In this manner, the foot airbag 71 is inflated and deployed in a substantially T shape to protect both legs 101 of the occupant 100. Since the foot airbag 71 is inflated and deployed in a substantially T shape, it is possible to prevent the legs 101 of the occupants 100 facing each other from colliding and getting injured when an impact force acts on the vehicle 1B.

### Third Modification

In the second modification, the foot airbag 71 is inflated and deployed in a substantially T shape. However, the foot airbag 71 is not limited to be inflated and deployed in a substantially T shape, and may be configured to be inflated and deployed in front of both legs 101 of the occupant 100. For example, the foot airbag 71 may be configured to emerge from the side surface of the seat cushion 311A, wrap around the front surfaces of both legs 101 of the occupant 100 so as to be inflated and deployed.

### Fourth Modification

In the first embodiment described above, the floor airbag module 4 is accommodated in the recess 14a formed in the floor surface 14. However, the floor airbag module 4 may be disposed between the front seat 2 in the second posture and the rear seat 3. For example, the floor airbag module 4 may be disposed on the floor surface 14 between the front seat 2 in the second posture and the rear seat 3.

### Fifth Modification

In the first embodiment described above, the floor airbag module 4 is used as the protective device. However, the protective device only needs to be configured to emerge between the front seat 2 and the rear seat 3 when an impact force acts on the subject vehicle 1 or when an impact force is predicted to act on the subject vehicle 1. For example, with the above configuration, the legs of the occupants sitting on the front seat 2 and the rear seat 3 may be protected, or at least one leg of each of the occupants sitting on the front seat 2 and the rear seat 3 may be protected. By protecting at least one leg, it is possible to prevent the legs of the occupants facing each other from vigorously colliding with each other.

### Sixth Modification

In the first embodiment described above, the vehicle 1 has been described in which the front seat 2 is rotated by 180 degrees so that the front seat 2 and the rear seat 3 can face each other. However, it may be used in a vehicle configured such that the front seat 2 and the rear seat 3 can face each other by rotating the seat back 212 of the front seat 2 from the rear to the front.

### Second Embodiment

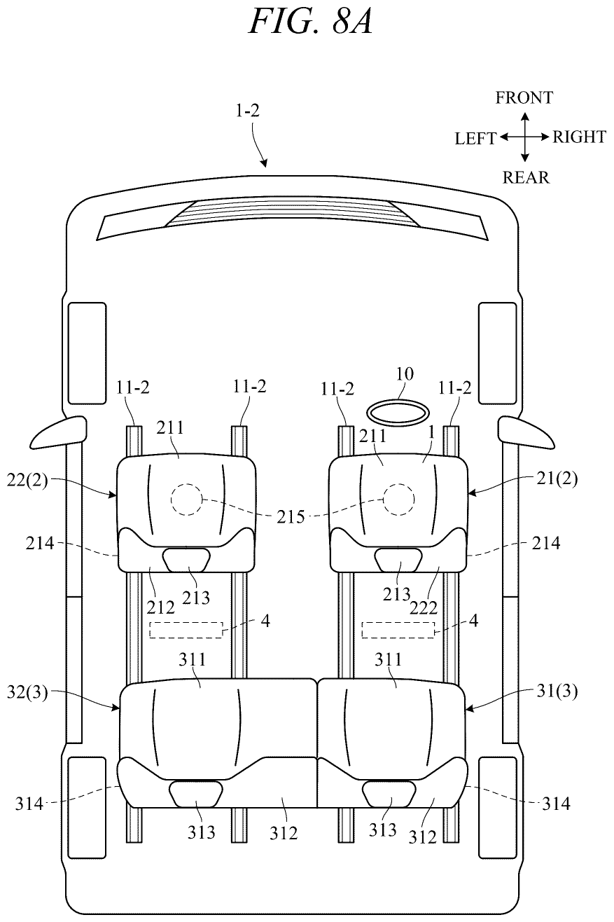

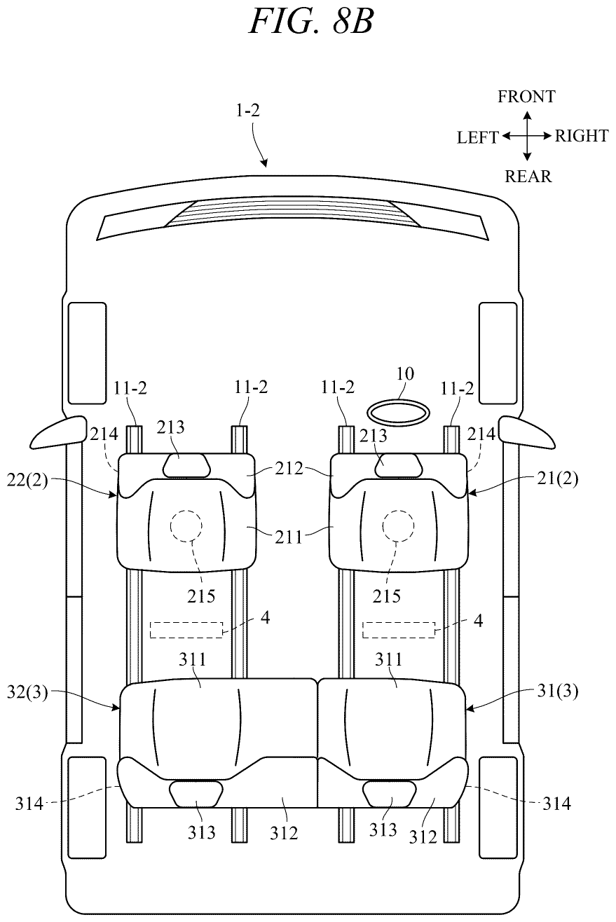

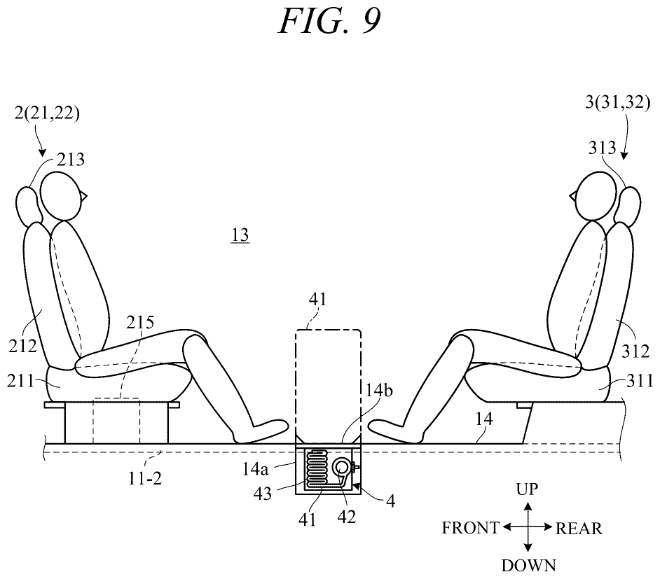

Next, a second embodiment of the present invention will be described with reference to FIGS. 8A to 9. In the second embodiment, the same reference signs are given to the same configurations as those of the first embodiment, and the description thereof will be omitted, and differences from the first embodiment will be mainly described.

FIG. 8A is a plan view illustrating a first seat layout of a vehicle 1-2 according to the second embodiment, and FIG. 8B is a plan view illustrating a second seat layout of the vehicle 1-2 according to the second embodiment. FIG. 9 is a side view illustrating the floor airbag module 4 provided between the front seat 2 in the second posture and the rear seat 3 illustrated in FIG. 8B. In the first embodiment described above, each of the front seat 2 and the rear seat 3 is configured to be slidable on the pair of left and right slide rails 11 and 12 provided individually. However, as illustrated in FIGS. 8A to 9, each of the front seat 2 and the rear seat 3 may be configured to be slidable on the pair of left and right slide rails 11-2 in common.

More specifically, the pair of left and right slide rails 11-2 is provided on each of the driver seat 21 side and the passenger seat 22 side so as to extend in the front-rear direction from the front portion to the rear portion in the vehicle interior 13 in the floor surface 14. The driver seat 21 and the driver seat side rear seat 31 are configured to be slidable on the pair of left and right slide rails 11-2 on the driver seat 21 side, and the passenger seat 22 and the passenger seat side rear seat 32 are configured to be slidable on the pair of left and right slide rails on the passenger seat 22 side. The floor airbag module 4 on the driver seat 21 side is provided between the slide rails 11-2 and 11-2 between the driver seat 21 and the driver seat side rear seat 31. On the other hand, the floor airbag module 4 on the passenger seat 22 side is provided between the slide rails 11-2 and 11-2 between the passenger seat 22 and the passenger seat side rear seat 32.

In this manner, the pair of left and right slide rails 11-2 on the driver seat 21 side and the passenger seat 22 side are shared by the front seat 2 and the rear seat 3, so that the floor airbag module 4 is disposed between the slide rails 11-2 and 11-2, and it is possible to suppress an increase in size of the floor airbag module 4 in the left-right direction (vehicle width direction).

### Third Embodiment

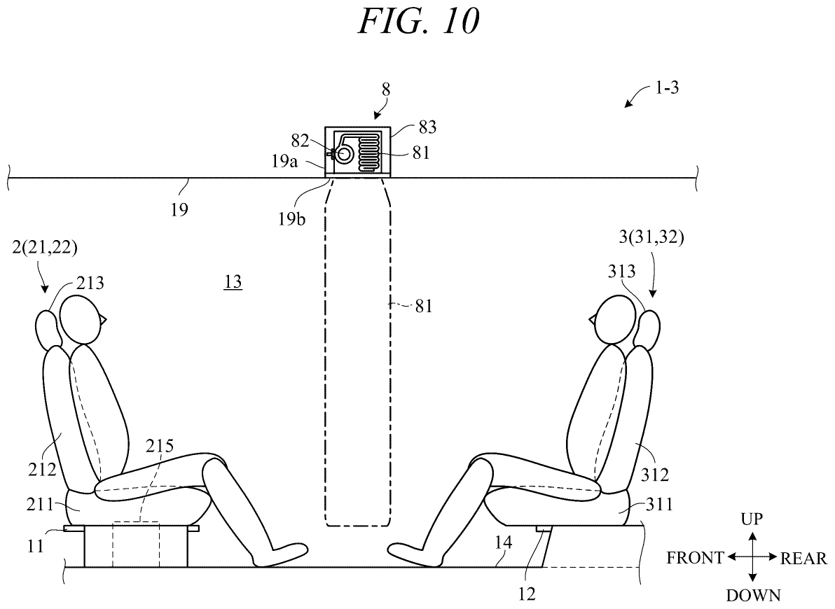

Next, a third embodiment of the present invention will be described with reference to FIG. 10. In the third embodiment, the same reference signs are given to the same configurations as those of the first and second embodiments, and the description thereof will be omitted, and differences from the first and second embodiments will be mainly described.

FIG. 10 is a side view illustrating the roof airbag module 8 provided on the ceiling 19 of the vehicle 1-3 according to the third embodiment. In the first and second embodiments described above, the floor airbag module 4 is provided on the floor surface 14 between the front seat 2 in the second posture and the rear seat 3. However, as illustrated in FIG. 10, the roof airbag module 8 may be provided on the ceiling 19 between the front seat 2 in the second posture and the rear seat 3.

More specifically, the roof airbag module 8 includes a roof airbag 81 and an inflator 82, and the roof airbag 81 and the inflator 82 are accommodated in the module case 83. The roof airbag module 8 each is provided on the ceiling 19 in the vehicle interior 13 so that the roof airbag 81 is inflated and deployed downward from the upper side between the driver seat 21 in the second posture and the driver seat side rear seat 31, and between the passenger seat 22 in the second posture and the passenger seat side rear seat 32.

The ceiling 19 has a recess 19a formed in a recessed shape upward, and the roof airbag module 8 is accommodated in the recess 19a so as not to protrude from the ceiling 19. The recess 19a is covered with a lid 19b so that the roof airbag module 8 is not exposed from the ceiling 19. The lid 19b is provided with a rupture portion (not illustrated), which is ruptured when the roof airbag 81 is inflated and deployed, and the roof airbag 81 emerges in the vehicle interior 13 via the rupture portion.

Similarly to the floor airbag module 4, the roof airbag module 8 is controlled by the airbag ECU 5. As described above, by providing the roof airbag module 8 instead of the floor airbag module 4, it is easy to secure a space for disposing a battery or the like beneath the floor surface 14 of the vehicle 1-3.

The above-described third embodiment can be modified into various modes. Hereinafter, modifications of the third embodiment will be described. Note that, in the following modifications, the same reference signs are given to the same configurations as those of the third embodiment, and the description thereof will be omitted, and differences from the third embodiment will be mainly described.

### First Modification

In the third embodiment described above, the roof airbag 81 is provided to be inflated and deployed downward from the upper side between the driver seat 21 in the second posture and the driver seat side rear seat 31 and between the passenger seat 22 in the second posture and the passenger seat side rear seat 32. However, the roof airbag 81 may be configured such that the distal end portion is brought into contact with the floor surface 14 when inflated and deployed downward from the upper side. By bringing the roof airbag 81 into contact with the floor surface 14 when the roof airbag 81 is deployed, it is easy to partition the occupant seated on the front seat 2 and the occupant seated on the rear seat 3.

### Second Modification

In the third embodiment described above, the roof airbag module 8 is accommodated in the recess 19a of the ceiling 19, but the roof airbag module 8 accommodated in the recess 19a may be moved in conjunction with or integrally with the movement of the front seat 2 or the rear seat 3. Since the roof airbag module 8 moves in conjunction with or integrally with the movement of the front seat 2 or the rear seat 3, the roof airbag 81 can be deployed at an appropriate position between the front seat 2 and the rear seat 3.

### Third Modification

In the third embodiment described above, when the action of the impact force on the subject vehicle 1 by the airbag ECU 5 or the action of the impact force on the subject vehicle 1 is predicted, the roof airbag 81 is simply deployed downward from the upper side. However, a detection device capable of detecting the state of the occupant may be provided on the ceiling 19, and the operation amount and the like of the roof airbag 81 may be controlled on the basis of the detected state of the occupant.

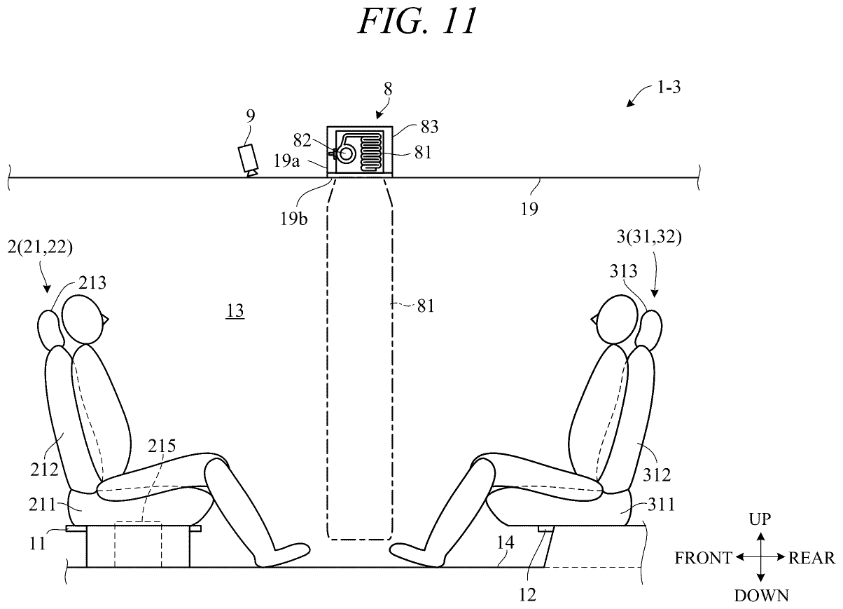

FIG. 11 is a side view illustrating the roof airbag module 8 and a detection device provided on the ceiling 19 of the vehicle 1-3 according to a third modification of the third embodiment. In the third modification, the detection device includes a camera 9. In the third modification, when the airbag ECU 5 predicts the action of the impact force on the subject vehicle 1 or the action of the impact force on the subject vehicle 1, the amount of gas generated by the inflator 82 is adjusted on the basis of the state of the occupant imaged by the camera 9. For example, when the feet of the occupant seated on the front seat 2 or the rear seat 3 is located immediately below the roof airbag module 8, the roof airbag 81 is controlled to be deployed to such an extent that the roof airbag 81 does not contact the feet of the occupant.

### Fourth Embodiment

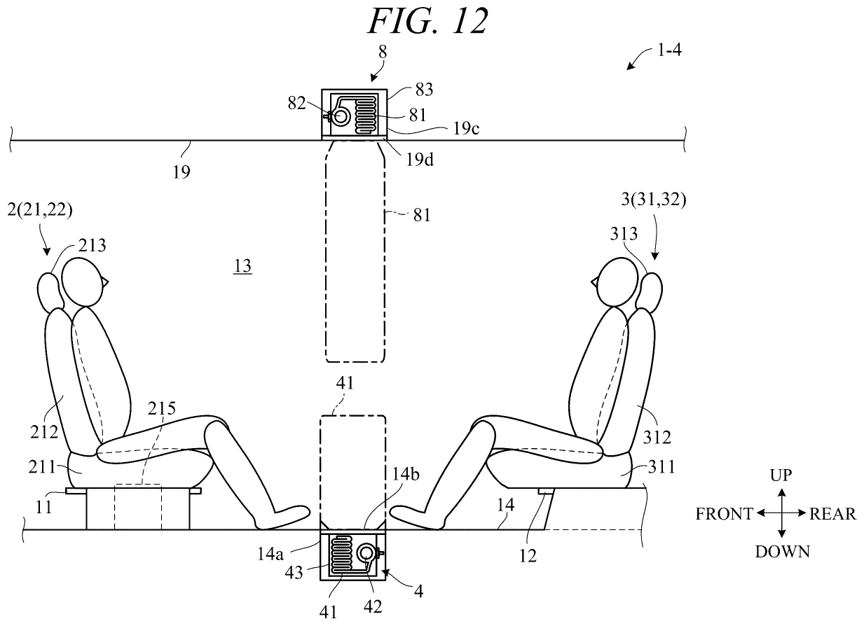

Next, a fourth embodiment of the present invention will be described with reference to FIG. 12. In the fourth embodiment, the same reference signs are given to the same configurations as those of the first to third embodiments, and the description thereof will be omitted, and differences from the first to third embodiments will be mainly described.

FIG. 12 is a side view illustrating the roof airbag module 8 and the floor airbag module 4 provided in the vehicle 1-4 according to the fourth embodiment. In the first to third embodiments, either the roof airbag module 8 or the floor airbag module 4 is provided, but as illustrated in FIG. 12, both may be provided. By providing the roof airbag module 8 and the floor airbag module 4, for example, the floor airbag module 4 can be downsized, and it is easy to secure a space for disposing a battery or the like under the floor surface 14.

The above-described fourth embodiment can be modified into various modes. Hereinafter, modifications of the fourth embodiment will be described. Note that, in the following modifications, the same reference signs are given to the same configurations as those of the fourth embodiment, and the description thereof will be omitted, and differences from the fourth embodiment will be mainly described.

### Modification

In the fourth embodiment described above, the floor airbag module 4 and the roof airbag module 8 are provided between the front seat 2 in the second posture and the rear seat 3, but the roof airbag module 8 may be provided on the front side in the vehicle interior 13.

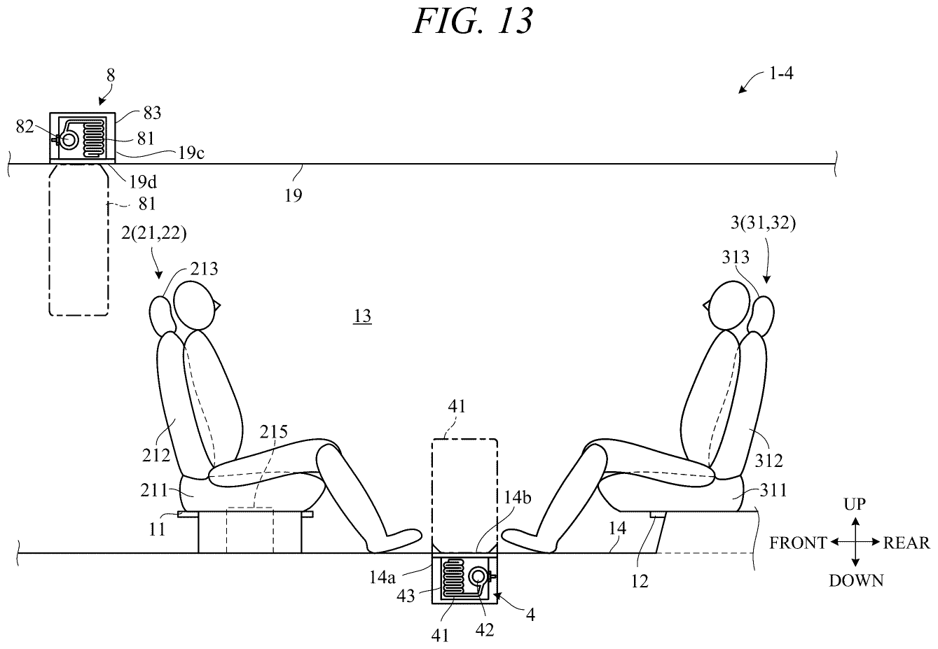

FIG. 13 is a side view illustrating a roof airbag module 8 and a floor airbag module 4 according to a modification of the fourth embodiment. As illustrated in FIG. 13, by providing the roof airbag module 8 on the front side of the ceiling 19, the head of the occupant seated in the front seat 2 in the second posture can be suitably protected.

### Fifth Embodiment

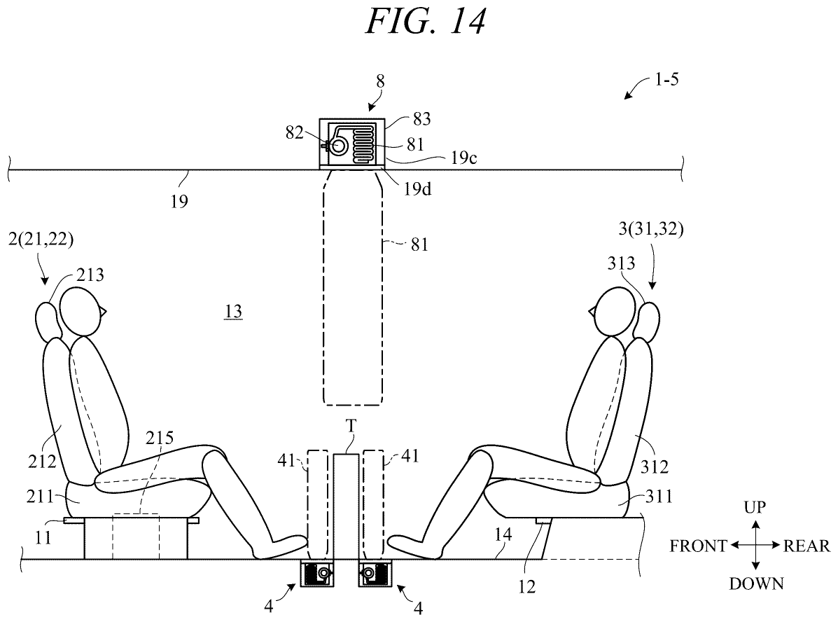

Next, a fifth embodiment of the present invention will be described with reference to FIG. 14. In the fifth embodiment, the same reference signs are given to the same configurations as those of the first to fourth embodiments, and the description thereof will be omitted, and differences from the first to fourth embodiments will be mainly described.

FIG. 14 is a side view illustrating a table T provided between a front seat 2 in a second posture and a rear seat 3 of the vehicle 1-5 according to the fifth embodiment. As illustrated in FIG. 14, the table T may be provided between the front seat 2 in the second posture and the rear seat 3. By providing the table T, the occupants seated on the front seat 2 in the second posture and the rear seat 3 can further relax. In this case, two floor airbag modules 4 may be arranged in the front-rear direction so as to sandwich the table T. By arranging the two floor airbag modules 4 in the front-rear direction so as to sandwich the table T, it is possible to prevent the occupant from contacting the table T even when an impact force or the like acts on the vehicle 1-5.

### First Modification

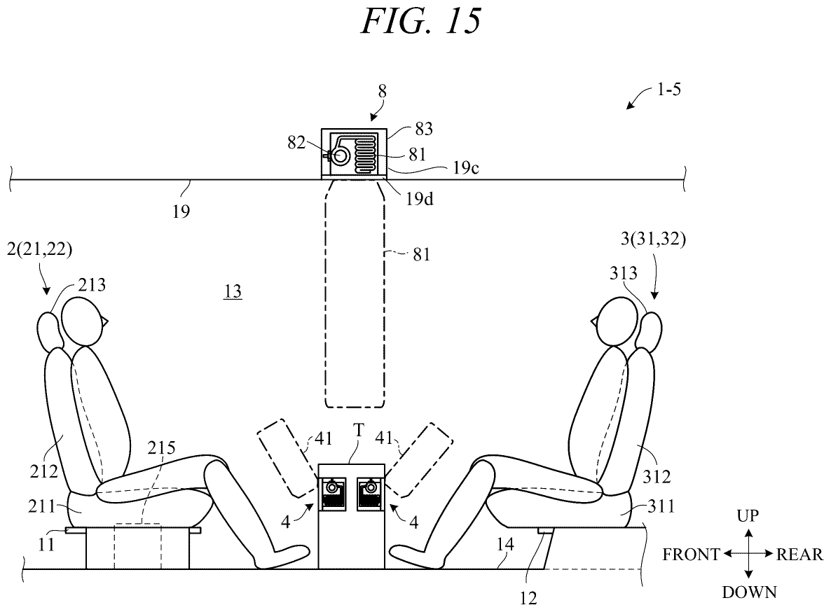

In the fifth embodiment described above, two floor airbag modules 4 are arranged in the front-rear direction so as to sandwich the table T, but may be provided in the table T. FIG. 15 is a side view illustrating two floor airbag modules 4 provided in a table T according to a modification of the fifth embodiment. As illustrated in FIG. 15, for example, the floor airbag modules 4 and 4 that are deployed toward the occupants seated on the front seat 2 and the rear seat 3, respectively, are provided in the table T, and the roof airbag module 8 is provided on the ceiling 19, so that the occupant can be suitably protected. In addition, by providing the roof airbag module 8 on the ceiling 19, the floor airbag modules 4 and 4 provided in the table T can be downsized.

### Second Modification

In the first modification described above, the floor airbag modules 4 and 4 are provided in the table T, the floor airbag modules 4 and 4 being deployed toward the occupants sitting on the front seat 2 and the rear seat 3, respectively. However, the table T may be moved in conjunction with or integrally with the movement of the front seat 2 or the rear seat 3. The floor airbag modules 4 and 4 may be provided in two tables arranged side by side in the front-rear direction, and the tables may be moved in conjunction with or integrally with the movement of the front seat 2 or the rear seat 3.

### Sixth Embodiment

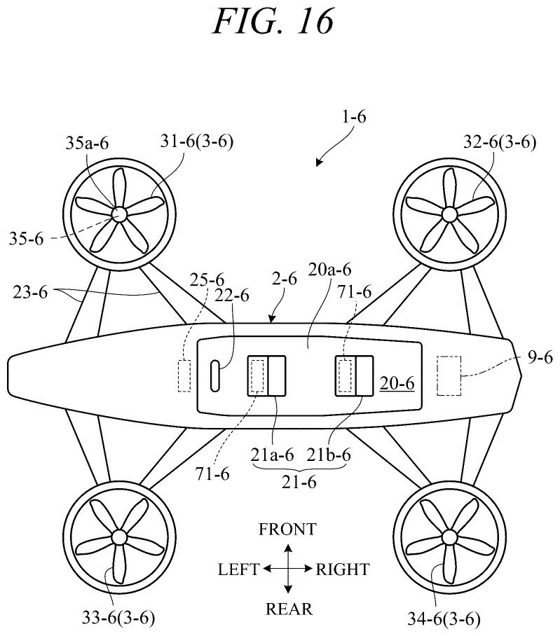

Next, a sixth embodiment of the present invention will be described with reference to FIGS. 16 to 22. A flight vehicle according to a sixth embodiment of the present invention is an electric flight vehicle called an eVTOL (electric vertical takeoff and landing) that vertically takes off and lands and flies. This type of flight vehicle has advantages such as no need for a runway and less noise due to electric power, and has attracted attention as a new vehicle required for urban air traffic. On the other hand, unlike an automobile traveling on the ground, this type of flight vehicle may receive an impact from the lower direction of the seat on which the occupant is seated when the balance is lost by being agitated by a gust or the like during flight. Therefore, in the present embodiment, the following flight vehicle is configured in order to reduce the impact that the occupant seated on the seat receives from below the seat during flight.

FIG. 16 is a plan view illustrating a configuration of a main part of a flight vehicle 1-6 according to a sixth embodiment of the present invention. Note that, in the following, for convenience, the front-rear direction, the left-right direction, and the up-down direction are defined as illustrated in the drawing, and each part is described according to this definition.

As illustrated in FIG. 16, the flight vehicle 1-6 includes a fuselage 2-6 and four rotary wings 3-6 that generate lift for flying in the air. The fuselage 2-6 has a long shape in the front-rear direction, and a cabin 20-6 for accommodating occupants is provided in a substantially central portion in the front-rear direction. The cabin 20-6 constitutes a seat arrangement part in which seats 21-6 on which each occupant is seated during flight is arranged. In the flight vehicle 1-6, four rotary wings 3-6 are arranged in four directions of the fuselage 2-6 around the cabin 20-6.

The cabin 20-6 is provided with a first seat 21a-6 on which a pilot is seated and a second seat 21b-6 on which a passenger is seated. The first seat 21a-6 is disposed on the front side of the cabin 20-6, the second seat 21b-6 is disposed on the rear side of the first seat 21a-6, and a control stick 22-6 for controlling the flight vehicle 1-6 is disposed in front of the first seat 21a-6. Note that, since the first seat 21a-6 and the second seat 21b-6 have the same configuration, hereinafter, the first and second seats 21a-6 and 21b-6 are referred to as seats 21-6, and a pilot and a passenger seated on the seats 21-6 are described as occupants.

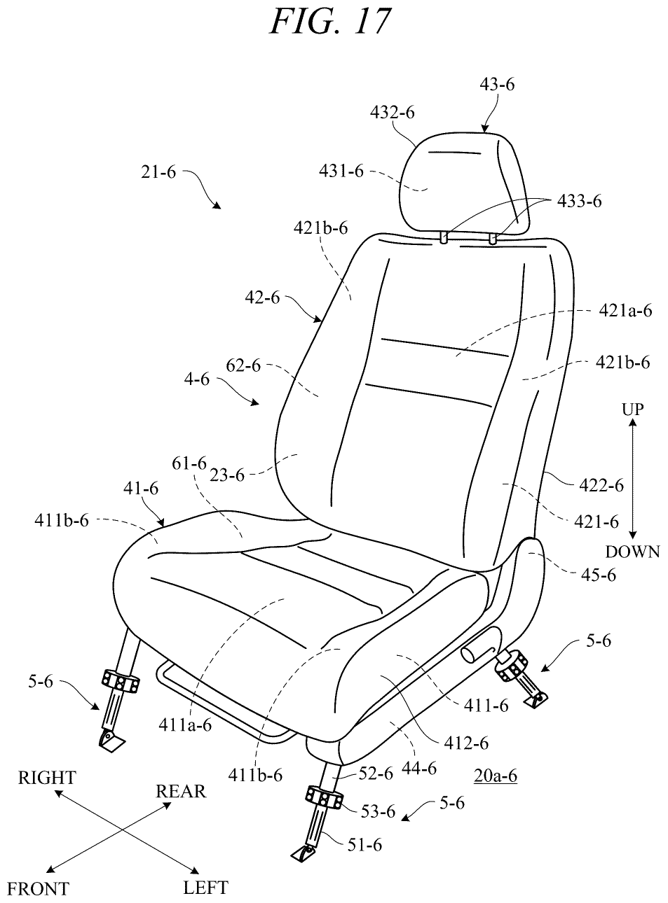

FIG. 17 is a perspective view illustrating a configuration of a main part of the seats 21-6 disposed in the cabin 20-6 of the flight vehicle 1-6. The front-rear direction, left-right direction, and up-down direction in the drawing correspond to the front-rear direction, left-right direction, and up-down direction in FIG. 16. In other words, the front of the front-rear direction is the direction in which the occupants seated on the seats 21-6 faces, the left-right direction is the width direction of the seats 21-6, and the up-down direction is the height direction of the seats 21-6.

As illustrated in FIG. 17, the seat 21-6 includes a seat part 4-6 on which the occupant is seated and four leg parts 5-6 that support the seat part 4-6. The seat part 4-6 includes a seat cushion 41-6 that supports the hip of the occupant, a seat back 42-6 that supports the back of the occupant, and a headrest 43-6 that supports the head of the occupant. The seat cushion 41-6 is configured to be movable on a pair of left and right seat rails 44-6 extending in the front-rear direction. The seat back 42-6 is disposed at a rear end portion of the seat cushion 41-6 and is configured to be tiltable with respect to the seat cushion 41-6 via a reclining mechanism 45-6. The headrest 43-6 is provided at an upper end of the seat back 42-6, and is configured to change a height position with respect to the seat back 42-6 in accordance with a position of a head of an occupant.

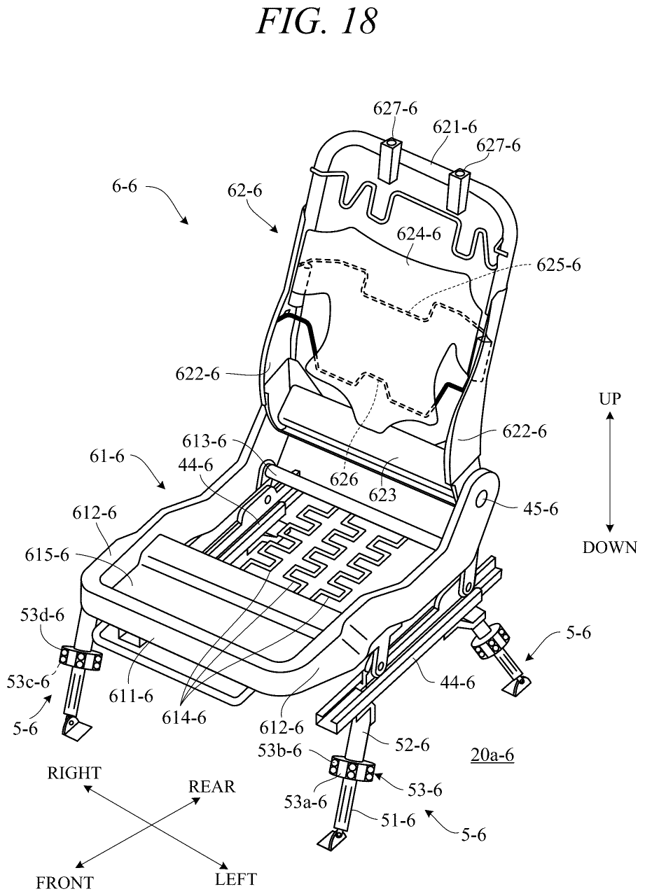

FIG. 18 is a perspective view showing a configuration of a main part of the seat frame 6-6 incorporated in the seat part 4-6. As illustrated in FIG. 18, a seat frame 6-6 includes a seat cushion frame 61-6, which is a frame corresponding to the seat cushion 41-6, and a seat back frame 62-6, which is a frame corresponding to the seat back 42-6. The seat cushion frame 61-6 and the seat back frame 62-6 are formed along the outer shapes of the seat cushion 41-6 and the seat back 42-6, respectively.

As illustrated in FIGS. 17 and 18, the seat cushion 41-6 is composed by mounting a cushion pad 411-6 made of a cushion material such as urethane foam or the like on the seat cushion frame 61-6 and covering the outside thereof with a skin material 412-6 made of synthetic leather or fabric. The cushion pad 411-6 is supported by the seat cushion frame 61-6 and functions as a pressure-receiving part that receives a load from the hip of the occupant. More specifically, the cushion pad 411-6 has a central portion 411a-6 in the left-right direction and side portions 411b-6 on both left and right sides thereof, and receives a downward load at the central portion 411a-6 and a side load at the side portions 411b-6.

The seat cushion frame 61-6 includes a front frame 611-6 extending in the left-right direction and constituting a front portion of the seat cushion frame 61-6, a pair of left and right side frames 612-6 extending in the front-rear direction and constituting left and right side portions of the seat cushion frame 61-6, and a rear frame 613-6 extending in the left-right direction and constituting a rear portion of the seat cushion frame 61-6. The front frame 611-6, the pair of left and right side frames 612-6, and the rear frame 613-6 are integrally coupled by welding or the like, and the seat cushion frame 61-6 is formed in a frame shape as a whole. Inside the frame-shaped seat cushion frame 61-6, a plurality of spring members 614-6 are provided so as to extend between the front frame 611-6 and the rear frame 613-6. The plurality of spring members 614-6 is formed in an elastically deformable bent shape and is formed by bending a wire or the like. The seat cushion frame 61-6 is attached to the four leg parts 5-6 and slidably engaged with a pair of left and right seat rails 44-6 extending in the front-rear direction, so that the seat cushion 41-6 is movable in the front-rear direction with respect to the fuselage 2-6.

The seat back 42-6 is composed by mounting a back pad 421-6 made of a cushion material on a seat back frame 62-6 serving as a skeleton, and by further covering the outside thereof with a skin material 422-6 made of synthetic leather or fabric. The back pad 421-6 is supported by the seat back frame 62-6 and functions as a pressure-receiving part that receives a load from the back of the occupant. More specifically, the back pad 421-6 has a central portion 421a-6 in the left-right direction and side portions 421b-6 on both left and right sides thereof, and receives a downward load at the central portion 421a-6 and a side load at the side portions 421b-6.

The seat back frame 62-6 extends in the left-right direction and includes an upper frame 621-6 that constitutes the upper part of the seat back frame 62-6, a pair of left and side frames 622-6 that are erected in the up-down direction and constitute the left and right side portions of the seat back frame 62-6, and a lower frame 623-6 that extends in the left-right direction and constitutes the lower part of the seat back frame 62-6. The upper frame 621-6, the pair of left and right side frames 622-6, and the lower frame 623-6 are integrally connected by welding or the like, and the seat back frame 62-6 is formed in a frame shape as a whole.

A back panel 624-6 is disposed inside the frame-shaped seat back frame 62-6. The back panel 624-6 is an elastically deformable plate-shaped member extending in the up-down direction and the left-right direction and is made of resin or the like. Behind the back panel 624-6, an upper connecting wire 625-6 and a lower connecting wire 626-6 extending each in the left-right direction are arranged. The upper connecting wire 625-6 and the lower connecting wire 626-6 are provided so as to be stretched between the left and right side frames 622-6, and the back panel 624-6 is supported by the pair of left and right side frames 622-6 via the upper connecting wire 625-6 and the lower connecting wire 626-6.

A lower portion of the seat back frame 62-6 is tiltably connected to a rear end portion of the seat cushion frame 61-6 via a reclining mechanism 45-6, whereby the seat back 42-6 can tilt with respect to the seat cushion 41-6.

The headrest 43-6 is composed by mounting a headrest pad 431-6 made of a cushion material on a core member serving as a skeleton, and by further covering the outside thereof with a skin material 432-6 made of synthetic leather or fabric. The headrest 43-6 is attached to the seat back frame 62-6 by inserting a pair of pipes 433-6 attached to the core member into a support bracket 627-6 provided on the upper frame 621-6 of the seat back frame 62-6.

In the seat 21-6, the seat cushion 41-6 includes a cushion airbag module 7-6 deployed on a seat surface of the seat cushion 41-6 and a foot airbag module 8-6 deployed at feet of an occupant seated on the seat 21-6. FIG. 19 is a cross-sectional view showing the configuration of the main part of the seat cushion 41-6 incorporating the cushion airbag module 7-6 and the foot airbag module 8-6.

As illustrated in FIG. 19, the seat cushion 41-6 includes a first airbag accommodation part 413-6 that accommodates the cushion airbag module 7-6 and a second airbag accommodation part 414-6 that accommodates the foot airbag module 8-6. The first airbag accommodation part 413-6 is formed in a substantially rectangular parallelepiped shape that is long in the left-right direction and the front-rear direction as a whole, and is disposed along the left-right direction at the front portion of the seat cushion 41-6.

The cushion airbag module 7-6 accommodated in the first airbag accommodation part 413-6 constitutes a device that absorbs an impact from below the seat 21-6 and protects the occupant seated on the seat 21-6. The cushion airbag module 7-6 may be a caseless airbag module having no module case, or may have a module case. In FIG. 19, the cushion airbag module 7-6 is a caseless airbag module.

The cushion airbag module 7-6 includes a cushion airbag 71-6 and an inflator 72-6. Both the cushion airbag 71-6 and the inflator 72-6 are wrapped in a wrap material or the like and held. The inflator 72-6 is a device that generates gas in response to an input signal from a harness (not illustrated in the drawings). The airbag ECU 9-6 outputs an operation signal to the inflator 72-6 when the acceleration in the up-down direction detected by the acceleration sensor (impact detection unit) 93-6 becomes equal to or greater than a preset threshold. When an operation signal is input to the inflator 72-6, the inflator 72-6 generates gas and injects the gas into the cushion airbag 71-6. As a result, the cushion airbag 71-6 bulges and deploys between the cushion pad 411-6 and the seat cushion frame 61-6. The cushion airbag 71-6 is configured to bulge and deploy to the entire seating surface of the seat cushion 41-6. For example, the cushion airbag 71-6 is folded and accommodated in the first airbag accommodation part 413-6 so as to be able to bulge and deploy over the entire seat surface, and when gas is injected, the cushion airbag bulges and deploys over the entire seat surface along the lower surface of the cushion pad 411-6. Since the cushion airbag 71-6 bulges and deploys over the entire seat surface of the seat cushion 41-6, an impact can be absorbed in a wide range from the lower direction, and the impact can be further reduced.

The cushion airbag module 7-6 is attached to an airbag holding part 615-6 attached to the seat cushion frame 61-6. The airbag holding part 615-6 is a plate-like member extending in the up-down direction and the left-right direction, and is formed by bending a steel plate. The airbag holding part 615-6 is integrally joined to the front frame 611-6 of the seat cushion frame 61-6 by welding or the like.

The second airbag accommodation part 414-6 is formed in a substantially rectangular parallelepiped shape that is long in the left-right direction as a whole, and is disposed along the left-right direction at the front end portion of the seat cushion 41-6. More specifically, the second airbag accommodation part 414-6 is disposed obliquely below and in front of the first airbag accommodation part 413-6, and is disposed slightly below the back of the knee of the occupant seated on the seat 21-6.

The foot airbag module 8-6 accommodated in the second airbag accommodation part 414-6 constitutes a device that absorbs an impact from below the seat 21-6, particularly an impact applied to the legs of the occupant, and protects the legs of the occupant. The foot airbag module 8-6 may be a caseless airbag module without a module case or may include a module case. In FIG. 19, the foot airbag module 8-6 includes a module case 83-6.

The foot airbag module 8-6 includes a foot airbag 81-6 and an inflator 82-6. Both the foot airbag 81-6 and the inflator 82-6 are wrapped and held in a wrap material or the like, and are accommodated in the module case 83-6. The inflator 82-6 is a device that generates gas in response to an input signal from a harness (not illustrated in the drawings). The airbag ECU 9-6 outputs an operation signal to the inflator 82-6 when the acceleration in the up-down direction detected by the acceleration sensor 93-6 becomes equal to or greater than a preset threshold. When an operation signal is input to the inflator 82-6, the inflator 82-6 generates gas and injects the gas into the foot airbag 81-6. As a result, the foot airbag 81-6 bulges and deploys at the feet of the occupant to protect both legs of the occupant. At this time, the foot airbag 81-6 bulges and deploys so as to wrap both legs of the occupant.

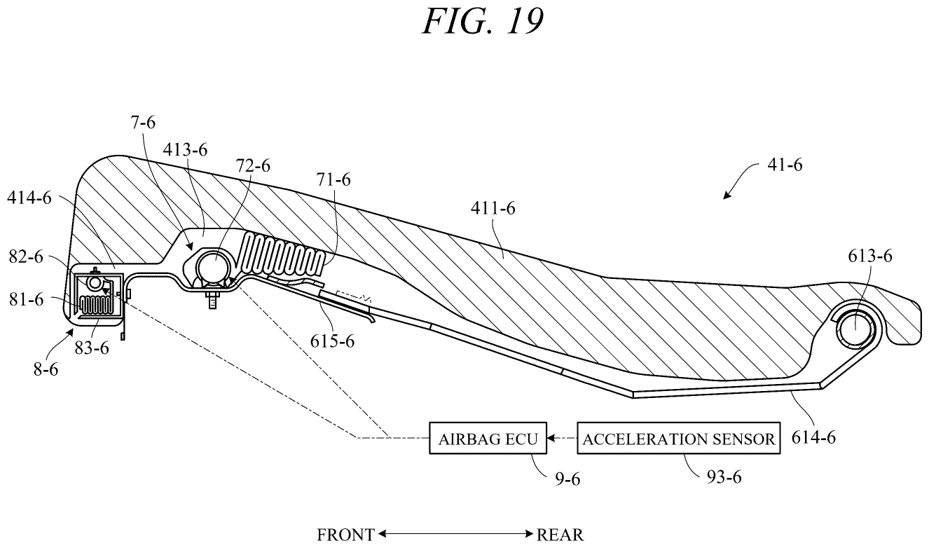

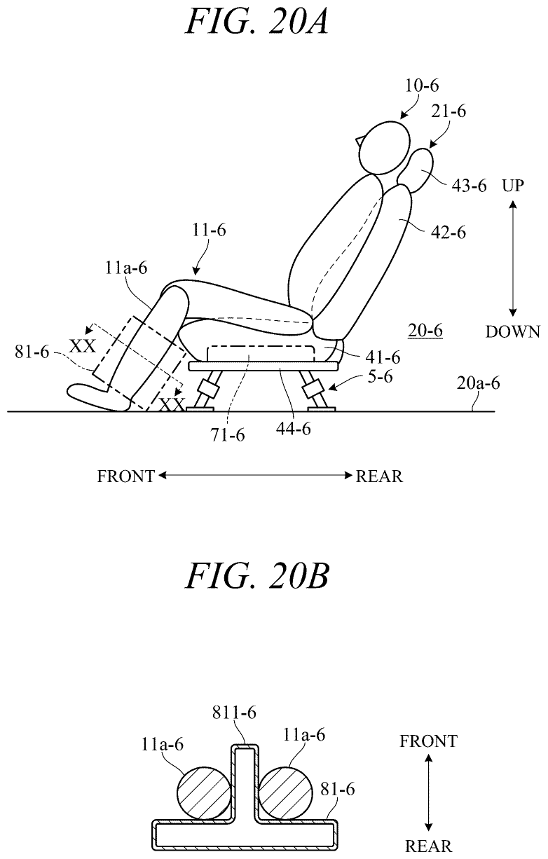

FIG. 20A is a side view schematically illustrating a state in which the cushion airbag 71-6 and the foot airbag 81-6 are deployed, and FIG. 20B is a cross-sectional view taken along line XX-XX of FIG. 20A. As shown in FIG. 20A, the cushioned airbag 71-6 bulges and deploys on the entire seat surface, and the foot airbag 81-6 bulges and deploys on the back side (calf side) of both legs 11-6 of the occupant 10-6. The foot airbag 81-6 is configured to be deployed in the entire back side of the below-knees 11a-6 of both legs 11-6, and also protrude to a gap between the below-knees 11a-6 of both legs 11-6 (between the below-knees 11a-6) as illustrated in FIG. 20B. That is, the foot airbag 81-6 bulges and deploys in a substantially convex shape to protect both legs 11-6 of the occupant 10-6. Since the foot airbag 81-6 bulges and deploys in a substantially convex shape, it is possible to prevent the legs from colliding with each other and getting injured when receiving an impact from the lower direction. For example, it is possible to prevent the knees of both legs 11-6 from hitting each other and injuring the knees. In addition, a protrusion portion 811-6 protruding forward in the gap between both the legs 11-6 protrudes such that the tip is positioned in front of both the legs 11-6. Therefore, even in a case where both legs 11-6 are thrown upward when receiving an impact from the lower direction, the tip of the protrusion 811-6 of the foot airbag 81-6 positioned in front of both legs 11-6 comes into contact with an obstacle or the like earlier than both legs 11-6, so that it is possible to reduce the impact received by both legs 11-6.

Note that, from the viewpoint of further reducing the impact applied to both the legs 11-6, it is preferable to provide the knee airbag 25-6 (see, for example, FIG. 16) in the upper portion of the cabin 20-6 where both the legs 11-6 of the occupant 10-6 are accommodated. By providing the knee airbag 25-6 in such a place, even when both legs 11-6 are thrown upward when an impact is received from below, both legs 11-6 of the occupant 10-6 can be sandwiched between the foot airbag 81-6 and the knee airbag 25-6. For a passenger seated on the second seat 21b-6, for example, a knee airbag can be provided below the seat back 42-6 of the first seat 21a-6.

One end of each of the four leg parts 5-6 is connected to four sides of the pair of left and right seat rails 44-6, and the other end thereof is connected to a floor surface 20a-6 of the cabin 20-6. That is, the seat part 4-6 is not directly installed on the floor surface 20a-6 of the cabin 20-6, but is installed on the floor surface 20a-6 of the cabin 20-6 via the four leg parts 5-6. In the seat 21-6, each of the four leg parts 5-6 is configured by a damper (shock absorber). Since the leg parts 5-6 supporting the seat part 4-6 is configured by the damper, the impact can be absorbed by the leg parts (damper) when the impact is received from the lower direction, and the impact received by the occupant can be reduced. The configuration can be simplified by using dampers as the leg parts 5-6 instead of providing dampers for the leg parts 5-6.

In the seat 21-6, the leg parts 5-6 are formed of friction dampers. More specifically, each of the leg parts 5-6 includes a cylindrical sliding portion 51-6, an accommodation part 52-6 configured to be able to accommodate the sliding portion 51-6 therein, and a friction generating portion 53-6 that generates a frictional force when the sliding portion 51-6 slides in the accommodation part 52-6. The sliding portion 51-6 is formed of a cylindrical piston rod, and has one end connected to a floor surface 20a-6 of the cabin 20-6. The accommodation part 52-6 is formed of a bottomed cylindrical cylinder, and a bottom portion thereof is connected to the seat rail 44-6. The friction generating portion 53-6 is provided at an insertion side end of the accommodation part 52-6 into which the sliding portion 51-6 is inserted. The friction generating portion 53-6 includes a pedestal portion 53a-6 having a plurality of through holes 53b-6 formed in the radial direction, a plurality of abutting portions 53c-6 inserted into the plurality of through holes 53b-6, and a plurality of urging portions 53d-6 that urge the plurality of abutting portions 53c-6 toward the sliding portion 51-6 accommodated in the accommodation part 52-6, and generates a frictional force by bringing the abutting portions 53c-6 into contact with the outer peripheral surface of the sliding portion 51-6.

The four rotary wings 3-6 are disposed around the cabin 20-6 in four directions of front, rear, left, and right of the fuselage 2-6. More specifically, the four rotary wings 3-6 include a first rotary wing 31-6 disposed on the right front side of the fuselage 2-6, a second rotary wing 32-6 disposed on the right rear side, a third rotary wing 33-6 disposed on the left front side, and a fourth rotary wing 34-6 disposed on the left rear side. Note that, since the first to fourth rotary wings 31-6 to 34-6 have the same configuration, the first rotary wing 31-6 will be described here, and the description of the second to fourth rotary wings 32-6 to 34-6 will be omitted.

The first rotary wing 31-6 is connected to a rotary shaft 35a-6 of a motor 35-6 attached to distal end portions of a pair of arms 23-6 and 23-6 extending rightward from a right side surface of the fuselage 2-6, and rotates by driving of the motor 35-6 to generate thrust. The motor 35-6 has an output capable of carrying the occupant 10-6, and is configured to be driven by receiving power supplied from a battery (not illustrated). Note that, as the first rotary wing 31-6 and the motor 35-6, those having the same configurations as those used for the electric flight vehicle such as the eVTOL can be used, and thus, a specific description thereof will be omitted here.

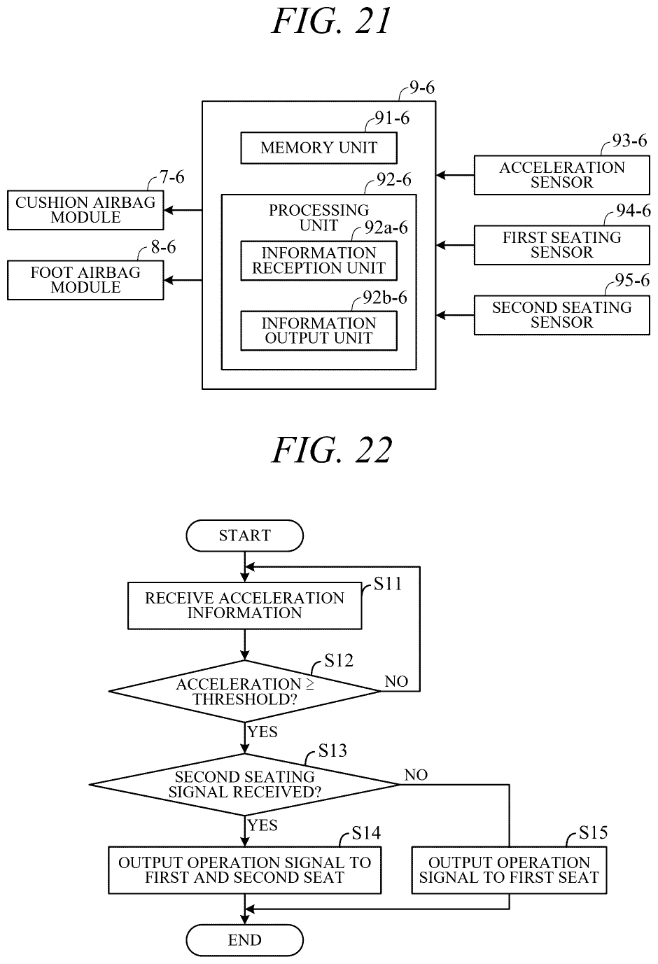

Next, an airbag ECU 9-6 that controls the cushion airbag module 7-6 and the foot airbag module 8-6 will be described. FIG. 21 is a block diagram illustrating a configuration of a main part of the airbag ECU 9-6.

As illustrated in FIG. 21, an acceleration sensor 93-6, a first seating sensor 94-6, and a second seating sensor 95-6 are connected to the airbag ECU 9-6. The acceleration sensor 93-6 detects acceleration in the up-down direction of the flight vehicle 1-6 and outputs the detected acceleration information to the airbag ECU 9-6. The first seating sensor 94-6 is provided on a seating surface (for example, between the cushion pad 411-6 and the skin material 412-6) of the first seat 21a-6, and outputs a first seating signal to the airbag ECU 9-6 when detecting seating of the pilot on the first seat 21a-6. The second seating sensor 95-6 is provided on a seating surface (for example, between the cushion pad 411-6 and the skin material 412-6) of the second seat 21b-6, and outputs a second seating signal to the airbag ECU 9-6 when detecting seating of the passenger on the second seat 21b-6.

The airbag ECU 9-6 includes a computer including a memory unit 91-6 such as a ROM, a RAM, and a hard disk, a processing unit 92-6 such as a CPU, and other peripheral circuits (not illustrated). The memory unit 91-6 stores various programs executed by the processing unit 92-6, various data, and the like. The memory unit 91-6 stores control data and the like for controlling the cushion airbag module 7-6 and the foot airbag module 8-6 on the basis of the acceleration in the up-down direction detected by the acceleration sensor 93-6. For example, a threshold of acceleration or the like when an operation signal is output to the inflators 72-6 and 82-6 of the cushion airbag module 7-6 and the foot airbag module 8-6, are stored.

The processing unit 92-6 includes an information reception unit 92a-6 and an information output unit 92b-6 as functional configurations. The information reception unit 92a-6 receives various types of information and the like transmitted from the sensor group. For example, the information reception unit 92a-6 receives the acceleration information input from the acceleration sensor 93-6, the first and second seating signals input from the first and second seating sensors, and the like. The information output unit 92b-6 outputs a predetermined signal to each unit on the basis of various types of information or the like received by the information reception unit 92a-6. For example, the information output unit 92b-6 outputs an operation signal to the inflators 72-6 and 82-6 when the acceleration in the up-down direction detected by the acceleration sensor 93-6 is equal to or greater than a preset threshold. At this time, when the information reception unit 92a-6 receives only the first seating signal, the information output unit 92b-6 outputs the operation signal only to the inflators 72-6 and 82-6 of the cushion airbag module 7-6 and the foot airbag module 8-6 provided in the first seat 21a-6. When the information reception unit 92a-6 receives the first and second seating signals, the information output unit 92b-6 outputs operation signals to the inflators 72-6 and 82-6 of the cushion airbag module 7-6 and the foot airbag module 8-6 provided in the first and second seats 21a-6 and 21b-6, respectively.

Next, an example of deployment processing of the cushion airbag 71-6 and the foot airbag 81-6 executed by the airbag ECU 9-6 included in the flight vehicle 1-6 configured as described above will be described. FIG. 22 is a flowchart illustrating an example of deployment processing executed by the airbag ECU 9-6.

First, in step S11, the acceleration information in the up-down direction output from the acceleration sensor 93-6 is received by the processing in the information reception unit 92a-6. Next, in step S12, it is determined whether or not the received acceleration information is equal to or more than a preset threshold by processing in the information output unit 92b-6. When negative determination is made in step S12, the processing returns to step S11.

On the other hand, when affirmative determination is made in step S12, the processing proceeds to step S13, and the information output unit 92b-6 determines whether or not the information reception unit 92a-6 has received the second seating signal by the processing in the information output unit 92b-6. When affirmative determination is made in step S13, the processing proceeds to step S14, and the operation signal is output to the inflators 72-6 and 82-6 of the cushion airbag module 7-6 and the foot airbag module 8-6 provided in the first and second seats 21a-6 and 21b-6 by the processing in the information output unit 92b-6 and the processing is terminated.

On the other hand, when negative determination is made in step S13, the processing proceeds to step S15, and the operation signal is output to the inflators 72-6 and 82-6 of the cushion airbag module 7-6 and the foot airbag module 8-6 provided in the first seat 21a-6 by the processing in the information output unit 92b-6, and the processing is terminated.

In the present embodiment, the following operations and effects are achievable.
(1) Flight vehicle 1-6 includes a fuselage 2-6 and rotary wings 3-6 rotatably supported by the fuselage 2-6, and is configured to fly in the air by generating thrust when rotary wings 3-6 rotate (FIG. 16). The fuselage 2-6 includes first and second seats 21a-6 and 21b-6 on which each of the occupants (pilot and passenger) 10-6 is seated, and a shock absorber (cushion airbag, foot airbag, damper) that absorbs an impact received from below the first and second seats 21a-6 and 21b-6 (FIG. 5A). With this configuration, even when an impact is received from below the first and second seats 21a-6 and 21b-6 on which each of the occupant 10-6 is seated during flight, the impact is absorbed by the shock absorber, so that the impact received by each of the occupants 10-6 seated on the first and second seats 21a-6 and 21b-6 can be reduced.
(2) The first and second seats 21a-6 and 21b-6 each have a seat part 4-6 and a plurality of leg parts 5-6 supporting the seat part 4-6. The shock absorber has dampers respectively used for the plurality of leg parts 5-6 (FIG. 2). With this configuration, when an impact is received from below, the impact can be absorbed by the dampers constituting the leg parts 5-6 of the first and second seats 21a-6 and 21b-6, so that the impact received by the occupants 10-6 seated on the first and second seats 21a-6 and 21b-6 can be reduced. The configuration of the leg parts 5-6 can be simplified by using dampers as the leg parts 5-6 instead of providing dampers for the leg parts 5-6.
(3) The first and second seats 21a-6, 21b-6 include a seat cushion 41-6 and a seat back 42-6 (FIG. 17). The shock absorber includes an acceleration sensor 93-6 that detects acceleration in the up-down direction acting on the seat cushion 41-6, and a cushion airbag 71-6 that is provided in the entire seating surface inside the seat cushion 41-6 and inflates when the acceleration sensor 93-6 detects acceleration equal to or greater than a predetermined threshold (FIG. 19). With this configuration, when an impact is received from below, the cushion airbag 71-6 can absorb the impact, and the impact received by the occupants 10-6 seated on the first and second seats 21a-6 and 21b-6 can be reduced. In particular, by deploying the cushion airbag 71-6 over the entire seat surface, an impact can be absorbed in a wide range from the downward direction, and the impact can be further reduced.
(4) The shock absorber further includes a foot airbag 81-6 provided inside the seat cushion 41-6 and inflated at the feet of the occupants 10-6 seated on the first and second seats 21a-6 and 21b-6 when acceleration equal to or greater than a predetermined threshold is detected by the acceleration sensor 93-6 (FIG. 19). With this configuration, the foot airbag 81-6 can absorb an impact when the impact is received from below, and the impact received by the occupants 10-6 seated on the first and second seats 21a-6 and 21b-6 can be reduced. In particular, the impact received by both legs 11-6 of occupants 10-6 can be reduced by allowing the foot airbag 81-6 to bulge and deploy at the feet of occupants 10-6.

The above-described sixth embodiment can be modified into various modes. Hereinafter, modifications of the sixth embodiment will be described. Note that, in the following modifications, the same reference signs are given to the same configurations as those of the sixth embodiment, and the description thereof will be omitted, and differences from the sixth embodiment will be mainly described.

### First Modification

In the sixth embodiment described above, the flight vehicle 1-6 including the first and second seats 21a-6 and 21b-6 having the cushion airbag 71-6 and the foot airbag 81-6 has been described. However, the flight vehicle may include, in addition to the airbag, a cockpit airbag deployed in front of the occupant (pilot) 10-6 seated on the first seat 21a-6, a passenger seat airbag deployed in front of the occupant (passenger) 10-6 seated on the second seat 21b-6, a pair of side airbags deployed on both sides of each of the occupants 10-6 seated on the first and second seats 21a-6 and 21b-6, a pair of curtain airbags deployed on both side surfaces of the cabin 20-6, and the like. By providing these airbags, even with respect to an impact from a direction other than the downward direction of the first and second seats 21a-6 and 21b-6, an impact received by the occupants 10-6 seated on the first and second seats 21a-6 and 21b-6 can be reduced, and the occupants 10-6 can be prevented from being injured or the like.

When the cabin 20-6 has an openable and closable or detachable ceiling (for example, a transparent capsule-like lid), a head airbag that deploys above the head of the occupant 10-6 when subjected to an impact may be provided on the ceiling. The head airbag is preferably deployed so as to surround the head. For example, the head airbag may be deployed to the front, rear, left, and right of the head of the occupant 10-6. By providing the head airbag, the head of the occupant 10-6 can be protected when the fuselage 2-6 receives an impact from below.

Similarly, when the cabin 20-6 has a ceiling, the pair of curtain airbags described above may be deployed from the ceiling along the side surface of the cabin 20-6, or the airbag may be deployed from the ceiling to the front and rear of each of the first and second seats 21a-6 and 21b-6, and the front, rear, left, and right of each of the first and second seats 21a-6 and 21b-6 may be surrounded by the airbag deployed from the ceiling.

In the configuration in which the front, rear, left, and right sides of each of the first and second seats 21a-6, 21b-6 are surrounded by an airbag, the first and second seats 21a-6, 21b-6 may be deployed not from the ceiling but from the floor surface 20a-6 of the cabin 20-6. By deploying the airbag from the floor surface 20a-6, a gap between the deployed airbag and the floor surface 20a-6 is eliminated, and for example, an impact from obliquely below each of the first and second seats 21a-6, 21b-6 can be reduced.

### Second Modification

In the sixth embodiment described above, the foot airbag 81-6 is provided inside the seat cushion 41-6 to protect both legs 11-6 of the occupant 10-6. However, the foot airbag 81-6 may be provided on the floor surface 20a-6 of the cabin 20-6 to bulge and deploy from the floor surface 20a-6 to protect both legs 11-6 of the occupant 10-6. In this case, it is preferable that the foot airbag is allowed to bulge and deploy in a substantially cylindrical shape, and both legs 11-6 of the occupant 10-6 are positioned in a space at the center of the foot airbag to protect the foot airbag so as to wrap both legs.

### Third Modification

The sixth embodiment has been described using the flight vehicle 1-6 including the four rotary wings 3-6, but the number of rotary wings 3-6 is not limited thereto. In the above embodiment, flight vehicle 1-6 including first and second seats 21a-6, 21b-6 has been described. However, the number of seats 21-6 is not limited to this.

### Fourth Modification

In the sixth embodiment described above, the friction damper is used as the damper used for each of the four leg parts 5-6, but the type of the damper is not limited thereto. The damper may be, for example, a damper using oil, gas, a spring, or the like.

### Fifth Modification

In the sixth embodiment, an electric flight vehicle that rotates the rotary wings 3-6 by driving the motor 35-6 with electric power stored in advance in the battery has been described as the flight vehicle 1-6. However, the flight vehicle may be a flight vehicle that generates electric power with other power to supply electric power to the battery, and drives the motor with the electric power to rotate the rotary wings. The flight vehicle may not be an electric flight vehicle.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1 vehicle (subject vehicle), 2 front seat, 3 rear seat, 4 floor airbag module (protective device), 5 airbag ECU, 14 floor surface, 14a recess, 21 driver seat, 22 passenger seat, 41 floor airbag

1. A vehicle, comprising:
a front seat capable of changing a posture between a first posture in which a seating surface of the front seat faces forward and a second posture in which the seating surface of the front seat faces backward;
a rear seat disposed behind the front seat, a seating surface of the rear seat facing forward; and
a protective device emerging between the front seat and the rear seat when impact force acts on the vehicle or when impact force is predicted to act on the vehicle.

2. The vehicle according to claim 1, wherein
the protective device includes an airbag configured to be inflated and deployed between the front seat in the second posture and the rear seat.

3. The vehicle according to claim 2, wherein the airbag is disposed on a floor surface so as to be inflated and deployed upward from lower side.

4. The vehicle according to claim 3, wherein
the floor surface includes a recess formed in a recessed shape downward, wherein
the airbag is accommodated in the recess.

5. The vehicle according to claim 2, further comprising:
a pair of left and right slide rails extending on the floor surface in a front-rear direction, wherein
the rear seat includes a pair of left and right engaging portions slidably engaged with the pair of left and right slide rails, wherein
the airbag is connected to the rear seat so as to move integrally with the rear seat.

6. The vehicle according to claim 1, further comprising:
a pair of left and right slide rails extending on the floor surface in a front-rear direction, wherein
the protective device includes an airbag configured to be inflated and deployed between the front seat in the second posture and the rear seat, wherein
each of the front seat and the rear seat includes a pair of left and right engaging portions slidably engaged with the pair of left and right slide rails, wherein
the airbag is configured to move in conjunction with movement of the front seat or the rear seat.

7. The vehicle according to claim 6, wherein
the airbag is disposed on a ceiling so as to be inflated and deployed downward from upper side.

8. A flight vehicle including a fuselage and a rotary wing rotatably supported by the fuselage, and configured to fly in air by generating thrust when the rotary wing rotates, wherein
the fuselage includes a seat on which an occupant is seated, and a shock absorber absorbing impact received from below the seat.

9. The vehicle according to claim 3, further comprising:
a pair of left and right slide rails extending on the floor surface in a front-rear direction, wherein
the rear seat includes a pair of left and right engaging portions slidably engaged with the pair of left and right slide rails, wherein
the airbag is connected to the rear seat so as to move integrally with the rear seat.

10. The vehicle according to claim 4, further comprising:
a pair of left and right slide rails extending on the floor surface in a front-rear direction, wherein
the rear seat includes a pair of left and right engaging portions slidably engaged with the pair of left and right slide rails, wherein
the airbag is connected to the rear seat so as to move integrally with the rear seat.
